(19) United States
(12) Patent Application Publication
(10) Pub. No.: US 2025/0202306 A1
(43) Pub. Date: Jun. 19, 2025

(54) ROTARY ELECTRIC MACHINE

(71) Applicant: DENSO CORPORATION, Kariya-city (JP)

(72) Inventors: HIROAKI KAJIURA, Kariya-city (JP); YU KUWAHARA, Kariya-city (JP)

(21) Appl. No.: 19/063,872

(22) Filed: Feb. 26, 2025

Related U.S. Application Data
(63) Continuation of application No. PCT/JP2023/029969, filed on Aug. 21, 2023.

(30) Foreign Application Priority Data
Aug. 30, 2022 (JP) 2022-137299

(51) Int. Cl. H02K 3/28; H02K 16/02

(52) U.S. Cl. CPC H02K 3/28; H02K 16/02

(57) ABSTRACT

A motor includes multiple coil portions. In each of the coil portions, multiple coil annular portions are stacked in a winding axial direction. The multiple coil annular portions are formed by a coil wire. The multiple coil annular portions include a conductor-divided annular portion. The conductor-divided annular portion includes a conductor-divided portion and a conductor-integrated portion. The conductor-divided portion includes divided conductors and dividing gaps in addition to a coil coating. Multiple divided conductors are arranged in a winding radial direction in the conductor-divided portion. Two of the divided conductors adjacent to each other in the winding radial direction are located at positions away from each other with the one of the dividing gaps interposed therebetween.

### CROSS REFERENCE TO RELATED APPLICATION

The present application is a continuation application of International Patent Application No. PCT/JP2023/029969 filed on Aug. 21, 2023, which designated the U.S. and claims the benefit of priority from Japanese Patent Application No. 2022-137299 filed on Aug. 30, 2022. The entire disclosures of all of the above applications are incorporated herein by reference.

### TECHNICAL FIELD

The present disclosure relates to a rotary electric machine.

### BACKGROUND

Conventionally, a rotary electric machine including a coil has been widely used.

### SUMMARY

According to an aspect of the present disclosure, a rotary electric machine is driven by supply of electric power. The rotary electric machine comprises a rotor and a stator.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a vertical cross-sectional view of an EPU according to a first embodiment;

FIG. 2 is a vertical cross-sectional view of a motor device;

FIG. 3 is a horizontal cross-sectional view of the motor device;

FIG. 4 is a diagram showing a configuration of an eVTOL;

FIG. 5 is a diagram showing an electrical configuration of a driving system;

FIG. 6 is a perspective view of a coil-portion unit;

FIG. 7 is an exploded perspective view of the coil-portion unit;

FIG. 8 is a diagram showing a winding direction of a coil wire in the coil-portion unit;

FIG. 9 is a side view of the coil-portion unit as viewed from a first coil portion side;

FIG. 10 is a plan view of a conductor-divided annular portion of the coil-portion unit as viewed from a lead-out wire side;

FIG. 11 is a vertical cross-sectional view of a conductor-divided portion;

FIG. 12 is a vertical cross-sectional view of a conductor-integrated portion;

FIG. 13 is a plan view of a conductor-integrated annular portion of the coil-portion unit as viewed from the lead-out wire side;

FIG. 14 is a front view of the coil-portion unit viewed from an outer wall peripheral portion side;

FIG. 15 is a diagram illustrating a pitch of a coil annular portion;

FIG. 16 is a diagram illustrating a thickness of a coil conductor;

FIG. 17 is a vertical cross-sectional view of a conductor-divided portion in a second embodiment;

FIG. 18 is a plan view of the conductor-divided annular portion in a third embodiment as viewed from the lead-out wire side;

FIG. 19 is a perspective view of an intersecting conductor;

FIG. 20 is a plan view of a first intersecting conductor and a second intersecting conductor;

FIG. 21 is a cross-sectional view taken along a line XXI-XXI in FIG. 20;

FIG. 22 is a diagram illustrating an eddy current generated in a comparative example;

FIG. 23 is a plan view of the first intersecting conductor and the second intersecting conductor in a fourth embodiment;

FIG. 24 is a cross-sectional view taken along a line XXIV-XXIV in FIG. 23;

FIG. 25 is a side view of the coil-portion unit in a fifth embodiment as viewed from the first coil portion side;

FIG. 26 is a plan view of a non-uniform annular portion of the coil-portion unit as viewed from the lead-out wire side;

FIG. 27 is a vertical cross-sectional view of the non-uniform annular portion;

FIG. 28 is a vertical cross-sectional view of a uniform annular portion;

FIG. 29 is a plan view of the uniform annular portion of the coil-portion unit as viewed from the lead-out wire side; and

FIG. 30 is a diagram illustrating a thickness of the annular conductor in a sixth embodiment.

### DETAILED DESCRIPTION

Hereinafter, examples of the present disclosure will be described.

According to an example of the present disclosure, a rotary electric machine includes an edgewise coil. In the rotary electric machine, the edgewise coil extends in a radial direction of the rotary electric machine. In the edgewise coil, a flat wire is wound to be stacked in the radial direction. By using the edgewise coil as a coil of a stator, a space factor of the coil can be increased.

However, it is considered that a cross-section of a conductor is increased due to the edgewise coil, and thus an eddy current would tend to be generated in the coil. Therefore, a DC copper loss tends to be reduced due to the increase in the space factor, whereas an AC copper loss tends to be increased due to the increase in the cross-section.

A disclosed first example is a rotary electric machine is to be driven by supply of electric power. The rotary electric machine comprises: a rotor configured to rotate about a rotation axis; and a stator adjacent to the rotor along the rotation axis and including a coil portion in which a plate-shaped coil wire is wound to be stacked in an axial direction of the rotation axis. The coil portion includes a conductor-arranged portion in which a conductor of the coil wire is divided into a plurality of parts. The conductor-arranged portion includes a plurality of arranged conductors arranged in a direction orthogonal to a winding direction of the coil wire, and an interposed portion provided between two of the arranged conductors adjacent to each other, and separating the arranged conductors from each other.

According to the first example, the multiple arranged conductors are arranged in the conductor-arranged portion of the coil portion. In the configuration, a cross-section of each of the arranged conductors can be reduced in size. Two arranged conductors adjacent to each other are provided at positions away from each other. In the configuration, even if an eddy current is generated in the conductor-arranged portion, the eddy current flows individually in each of the multiple arranged conductors. Therefore, the eddy current flowing along the cross-section of the arranged conductor is less likely to increase. Accordingly, the arranged conductors can limit an increase in an AC copper loss caused by an increase in the eddy current.

In the coil portion, since the plate-shaped coil wire is wound to be stacked, a space factor tends to increase. Therefore, an increase in a DC copper loss in the coil portion can be limited. Thus, the DC copper loss and the AC copper loss in the coil portion can be reduced.

A rotary electric machine is to be driven by supply of electric power. The rotary electric machine comprises: a rotor configured to rotate about a rotation axis; and a stator adjacent to the rotor along the rotation axis and including a coil portion in which a plate-shaped coil wire is wound to be stacked in an axial direction of the rotation axis. The coil portion includes: a first occupancy portion in which a proportion of a conductor in a cross-section of the coil wire is a first conductor ratio, and a second occupancy portion adjacent to the first occupancy portion in a winding direction of the coil wire and in which the proportion is a second conductor ratio. The first conductor ratio is smaller than the second conductor ratio.

According to the second example, in the coil portion, the first conductor ratio of the first occupancy portion is smaller than the second conductor ratio of the second occupancy portion. In the configuration, due to the fact that the proportion of the conductor in the first occupancy portion is low, the eddy current flowing along the cross-section of the conductor tends to be reduced. Therefore, the first occupancy portion can limit the increase in the AC copper loss caused by the increase in the eddy current Ie. Accordingly, as in the first example, a loss such as the DC copper loss and the AC copper loss occurring in the coil portion can be reduced.

In the configuration, due to the fact that the proportion of the conductor in the second occupancy portion is high, heat in the second occupancy portion is transferred more easily than heat in the first occupancy portion. That is, a heat dissipation effect in the second occupancy portion is higher than a heat dissipation effect in the first occupancy portion. Therefore, the second occupancy portion can prevent accumulation of heat in the coil portion. In this way, a heat dissipation effect in the coil portion can be improved by the second occupancy portion.

Hereinafter, multiple embodiments for carrying out the present disclosure will be described with reference to the drawings. In each embodiment, the same reference numerals are assigned to portions corresponding to the items described in the preceding embodiments, and a repetitive description thereof may be omitted. In each embodiment, when only a part of the configuration is described, another embodiment previously described can be employed for the other part of the configuration. Not only combinations between portions that are specifically clarified as being able to be used in combination in each embodiment are possible, but also partial combinations between the embodiments whose combination is not specifically clarified are possible as long as no adverse effect is particularly generated on the combination.

### First Embodiment

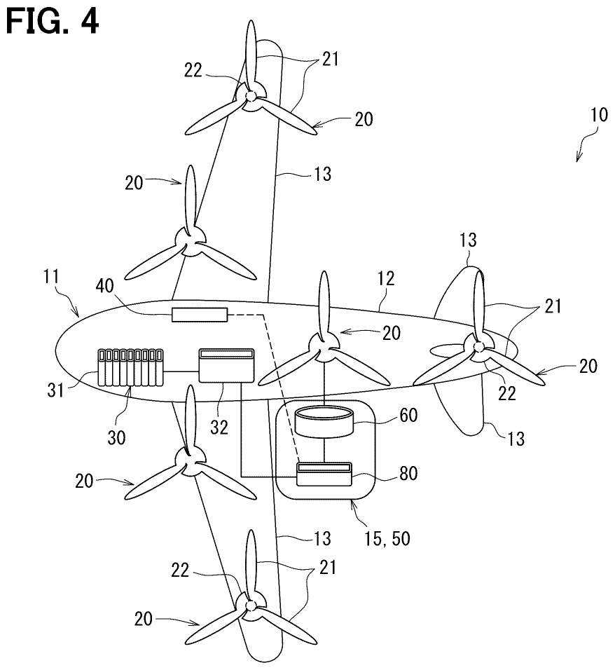

A driving system 30 shown in FIG. 4 is mounted on an eVTOL 10. The eVTOL 10 is an electric vertical take-off and landing aircraft, and can take off and land in a vertical direction. The eVTOL is an abbreviation of an electric vertical take-off and landing aircraft. The eVTOL 10 is an aircraft flying in the atmosphere and corresponds to a flight vehicle. The eVTOL 10 is also an electric-type electric aircraft and may be referred to as an electric flight vehicle. The eVTOL 10 is a manned aircraft carrying occupants. The driving system 30 is a system that drives the eVTOL 10 to fly.

The eVTOL 10 includes an airframe 11 and propellers 20. The airframe 11 includes an airframe main body 12 and wings 13. The airframe main body 12 is a body of the airframe 11 and has, for example, a shape extending in a front-rear direction. The airframe main body 12 has a passenger compartment for carrying occupants. Each of the wings 13 extends from the airframe main body 12 and multiple wings 13 are provided on the airframe main body 12. The wings 13 are fixed wings. The multiple wings 13 include a main wing, a tail wing, and the like.

Multiple propellers 20 are provided on the airframe 11. The eVTOL 10 is a multi-transponder including at least three propellers 20. For example, at least four propellers 20 are provided on the airframe 11. The propellers 20 are provided on the airframe main body 12 and the wings 13. Each of the propellers 20 rotates around a propeller axis. The propeller axis is, for example, a center line of the propeller 20. The propeller 20 can generate thrust and lift in the eVTOL 10. The propeller 20 may be referred to as a rotor or a rotary blade.

The propeller 20 includes blades 21 and a boss 22. The blades 21 are arranged in a circumferential direction of the propeller axis. The boss 22 couples the multiple blades 21. Each of the blades 21 extends from the boss 22 in a radial direction of the propeller axis. The propeller 20 includes a propeller shaft (not shown). The propeller shaft is a rotating shaft of the propeller 20 and extends along the propeller axis from the boss 22. The propeller shaft may be referred to as a propeller shaft.

The eVTOL 10 is a tilt-rotor aircraft. In the eVTOL 10, the propeller 20 can be tilted. That is, a tilt angle of the propeller 20 is adjustable. For example, when the eVTOL 10 ascends, an orientation of the propeller 20 is set such that the propeller axis extends in an upper-lower direction. In this case, the propeller 20 functions as a lift-rotor for generating lift in the eVTOL 10. The propeller 20 functions as a lift-rotor, enabling the eVTOL 10 to hover and take off and land vertically. When the eVTOL 10 moves forward, the orientation of the propeller 20 is set such that the propeller axis extends in a front-rear direction. In this case, the propeller 20 functions as a cruise-rotor for generating thrust in the eVTOL 10.

The eVTOL 10 includes a battery 31, a distributor 32, a flight control device 40, and EPUs 50. The battery 31, the distributor 32, the flight control device 40, and the EPU 50 are included in the driving system 30. The battery 31 is electrically connected to the multiple EPUs 50. The battery 31 is a power supplying unit that supplies electric power to the EPUs 50, and corresponds to a power supply unit. The battery 31 is a DC voltage source that applies a DC voltage to the EPUs 50. The battery 31 has a rechargeable secondary battery. The battery 31 also supplies electric power to the flight control device 40. In addition to or instead of the battery 31, a fuel cell, a generator, or the like may be used as the power supply unit.

The distributor 32 is electrically connected to the battery 31 and the multiple EPUs 50. The distributor 32 distributes the electric power from the battery 31 to the multiple EPUs 50. The electric power distributed to the EPUs 50 by the distributor 32 is drive power for driving the EPUs 50.

The flight control device 40 controls the driving system 30. The flight control device 40 performs flight control for causing the eVTOL 10 to fly. The flight control device 40 is communicably connected to the multiple EPUs 50. The flight control device 40 individually controls the multiple EPUs 50. The flight control device 40 controls the EPUs 50 via a control circuit 160 to be described later. The flight control device 40 controls the control circuit 160.

Each of the EPUs 50 is a device for driving the propeller 20 to rotate, and corresponds to a drive device. The EPU is an abbreviation of an electric propulsion unit. The EPU 50 may be referred to as a power drive device or a power drive system. The EPU 50 is provided individually for each of the multiple propellers 20. The EPU 50 is arranged on the propeller 20 along the propeller axis. All of the multiple EPUs 50 are fixed on the airframe 11. The EPU 50 rotatably supports the propeller 20. The EPU 50 is connected to the propeller 20. The propeller 20 is fixed to the airframe 11 with the EPU 50 interposed therebetween. When the tilt angle of the propeller 20 is changed, an angle of the EPU 50 is also changed.

The eVTOL 10 includes a propulsion device 15. The propulsion device 15 is a device for propelling the eVTOL 10. The eVTOL 10 can fly, such as lift, by propulsion of the propulsion device 15. The propulsion device 15 includes the propeller 20 and the EPU 50. In the propulsion device 15, the propeller 20 rotates as the EPU 50 is driven. The propeller 20 corresponds to a rotary body. The eVTOL 10 flies by rotating the propellers 20. That is, the eVTOL 10 moves by rotating the propellers 20. The eVTOL 10 corresponds to a moving object.

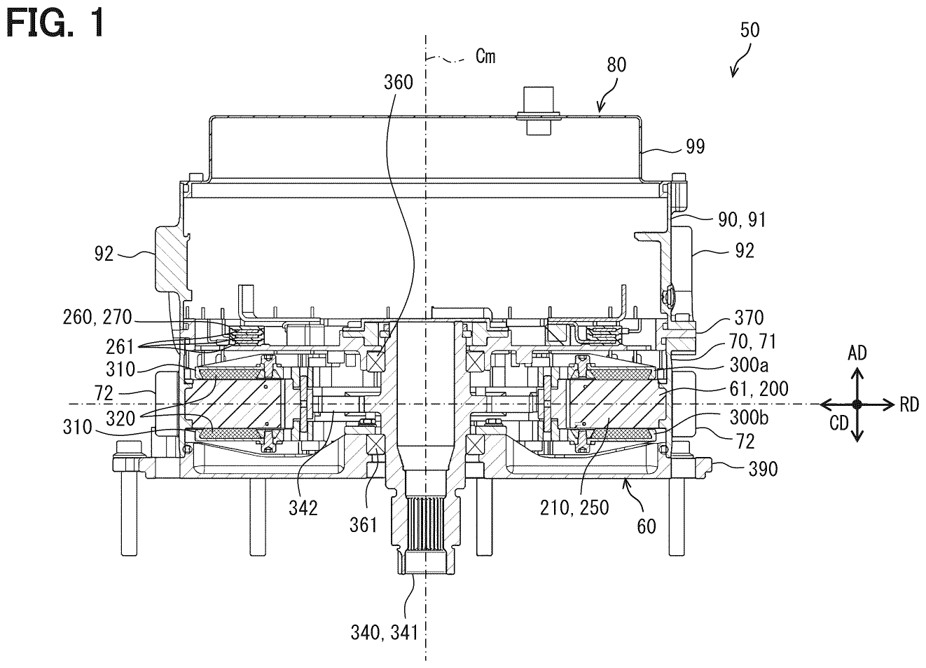

As shown in FIGS. 1, 4 and 5, the EPU 50 includes a motor device 60 and an inverter device 80. For example, the EPU 50 includes one motor device 60 and one inverter device 80. The motor device 60 includes a motor 61. The motor device 60 corresponds to a rotary electric machine. The inverter device 80 includes an inverter 81. The motor 61 is electrically connected to the battery 31 via the inverter 81. The motor 61 is driven in response to the electric power supplied from the battery 31 via the inverter 81.

The motor 61 is a multi-phase AC motor. The motor 61 is, for example, a three-phase AC motor, and has a U-phase, a V-phase, and a W-phase. The motor 61 is a moving driving source for moving the moving object, and functions as an electric motor. As the motor 61, for example, a brushless motor is used. The motor 61 functions as a generator during regeneration. The motor 61 includes coils 211 of multiple phases. The coils 211 are windings and form an armature. The coil 211 is provided for each of the U-phase, the V-phase, and the W-phase. In the motor 61, the coils 211 of multiple phases are connected to one another by a neutral point 65.

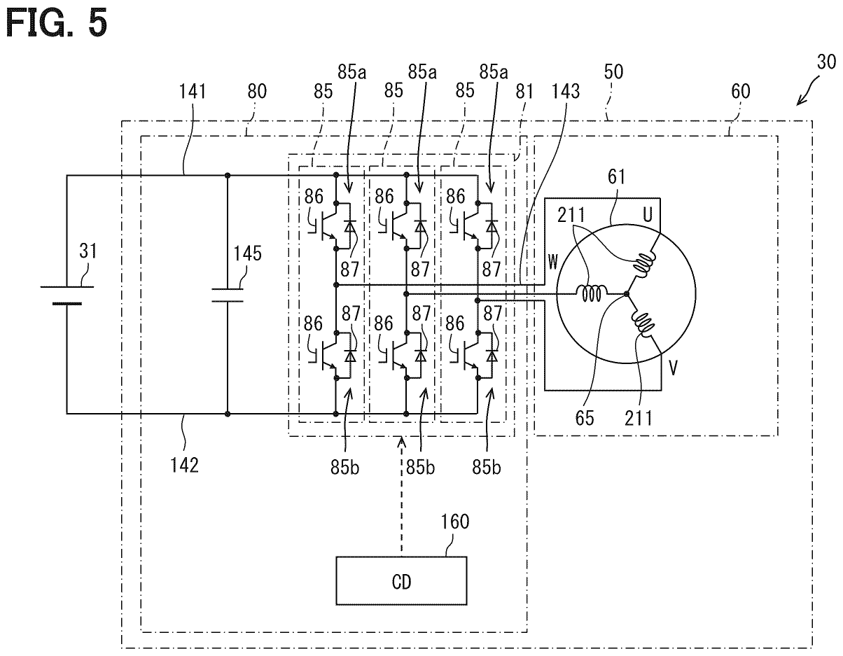

In FIG. 5, the inverter 81 drives the motor 61 by converting the electric power to be supplied to the motor 61. The inverter 81 converts the electric power supplied to the motor 61 from a direct current to an alternating current. The inverter 81 is a power conversion unit that converts the electric power. The inverter 81 is a multi-phase power conversion unit, and performs power conversion for each of the multiple phases. The inverter 81 is, for example, a three-phase inverter, and performs power conversion for each of the U-phase, the V-phase, and the W-phase. The inverter device 80 may be referred to as a power conversion device.

The inverter device 80 includes a P line 141 and an N line 142. The P line 141 and the N line 142 electrically connect the battery 31 and the inverter 81. The P line 141 is electrically connected to a positive electrode of the battery 31. The N line 142 is electrically connected to a negative electrode of the battery 31. In the battery 31, the positive electrode is an electrode on a high potential side, and the negative electrode is an electrode on a low potential side. The P line 141 and the N line 142 are power lines for supplying electric power. The P line 141 is a power line on the high potential side and may be referred to as a high potential line. The N-line 142 is a power line on the low potential side and may be referred to as a low potential line.

The EPU 50 has an output line 143. The output line 143 is a power line for supplying electric power to the motor 61. The output line 143 electrically connects the motor 61 and the inverter 81. The output line 143 spans the motor device 60 and the inverter device 80.

The inverter device 80 includes a smoothing capacitor 145. The smoothing capacitor 145 is a capacitor that smooths the DC voltage supplied from the battery 31. The smoothing capacitor 145 is connected to the P line 141 and the N line 142 between the battery 31 and the inverter 81. The smoothing capacitor 145 is connected in parallel to the inverter 81.

The inverter 81 is a power conversion circuit, for example, a DC-AC conversion circuit. The inverter 81 includes upper and lower arm circuits 85 corresponding the multiple phases. For example, the inverter 81 includes the upper and lower arm circuits 85 respectively for the U-phase, the V-phase, and the W-phase. The upper and lower arm circuit 85 may be referred to as a leg or arm circuit. Each of the upper and lower arm circuits 85 includes an upper arm 85a and a lower arm 85b. The upper arm 85a and the lower arm 85b are connected in series to the battery 31. The upper arm 85a is connected to the P line 141, and the lower arm 85b is connected to the N line 142.

The output line 143 is connected to the upper and lower arm circuit 85 for each of the multiple phases. The output line 143 is connected between the upper arm 85a and the lower arm 85b. The output line 143 connects the upper and lower arm circuit 85 and the coil 211 for each of the multiple phases. The output line 143 is connected to the coil 211 on a side opposite to the neutral point 65.

Each of the upper arm 85a and the lower arm 85b includes an arm switch 86 and a diode 87. The arm switch 86 is, for example, a transistor such as an MOSFET. The MOSFET is an abbreviation of a metal-oxide-semiconductor field-effect transistor. The arm switch 86 is a switching element, and can convert power by switching. The switch element may be a semi-conductor element such as a power element. The arm switch 86 is a conversion switch for converting electric power.

The EPU 50 includes a control circuit 160. The control circuit 160 is provided in the inverter device 80. The control circuit 160 controls driving of the inverter 81. The control circuit 160 controls driving of the motor 61 via the inverter 81. The control circuit 160 may be referred to as a motor control unit. In FIG. 5, the control circuit 160 is illustrated as CD.

The control circuit 160 is a control device such as an ECU. The ECU is an abbreviation of an electronic control unit. The control circuit 160 is mainly implemented by a microcomputer including, for example, a processor, a memory, an I/O, and a bus connecting these components. The memory is a non-transitory tangible storage medium that non-temporarily stores computer readable programs and data. The non-transitory tangible storage medium is a non-transitory tangible storage medium, and is implemented by a semi-conductor memory, a magnetic disk, or the like.

As shown in FIG. 1, in the EPU 50, the motor device 60 and the inverter device 80 are arranged in an axial direction AD along a motor axis Cm. The motor device 60 is provided between the propeller 20 and the inverter device 80 in the axial direction AD. The motor axis Cm is a center line of the motor 61 and is a virtual line extending linearly. The motor axis Cm corresponds to a rotation axis. The axial direction AD is a direction in which the motor axis Cm extends.

Regarding the motor axis Cm, the axial direction AD, a circumferential direction CD, and a radial direction RD are orthogonal to one another. The circumferential direction CD is a rotation direction of the motor 61. Regarding the radial direction RD, an outer side may be referred to as a radially outer side or an outer peripheral side, and an inner side may be referred to as a radially inner side or an inner peripheral side. The motor axis Cm coincides with the propeller axis. The axial direction AD may be referred to as a motor axial direction AD, the radial direction RD may be referred to as a motor radial direction RD, and the circumferential direction CD may be referred to as a motor circumferential direction CD. The motor axis Cm may be located at a position deviated from the propeller axis in the radial direction RD. FIG. 1 illustrates a vertical cross-section of the EPU 50 taken along the motor axis Cm.

The EPU 50 includes a motor housing 70 and an inverter housing 90. The motor housing 70 is provided in the motor device 60. The motor housing 70 accommodates the motor 61. The inverter housing 90 is provided in the inverter device 80. The inverter housing 90 accommodates the inverter 81. The motor housing 70 and the inverter housing 90 are connected to each other.

The EPU 50 includes a motor outer peripheral wall 71, an inverter outer peripheral wall 91, an inverter cover 99, a rear frame 370, and a drive frame 390. Each of the outer peripheral walls 71, 91, the inverter cover 99, and the frames 370, 390 is made of a metal material or the like and has a thermal conduction property. Each of the motor outer peripheral wall 71 and the inverter outer peripheral wall 91 extends in an annular shape in the circumferential direction CD. Each of the inverter cover 99, the rear frame 370, and the drive frame 390 is formed in a plate shape and extends in a direction orthogonal to the axial direction AD.

The motor housing 70 includes the motor outer peripheral wall 71, the rear frame 370, and the drive frame 390. The inverter housing 90 includes the inverter outer peripheral wall 91, the inverter cover 99, and the rear frame 370. The motor outer peripheral wall 71 and the inverter outer peripheral wall 91 are arranged in the axial direction AD with the rear frame 370 interposed therebetween. The inverter cover 99 and the drive frame 390 are arranged in the axial direction AD with the motor outer peripheral wall 71, the inverter outer peripheral wall 91, and the rear frame 370 interposed therebetween.

The motor housing 70 includes motor fins 72. The motor fins 72 are provided on an outer surface of the motor outer peripheral wall 71. The motor fins 72 extend from the motor outer peripheral wall 71 toward the outer peripheral side. The motor fins 72 are heat dissipation fins that dissipate heat of the motor device 60 to the outside. The inverter housing 90 includes inverter fins 92. The inverter fins 92 are provided on an outer surface of the inverter outer peripheral wall 91. The inverter fins 92 extend from the inverter outer peripheral wall 91 toward the outer peripheral side. The inverter fins 92 are heat dissipation fin that dissipate heat of the inverter device 80 to the outside.

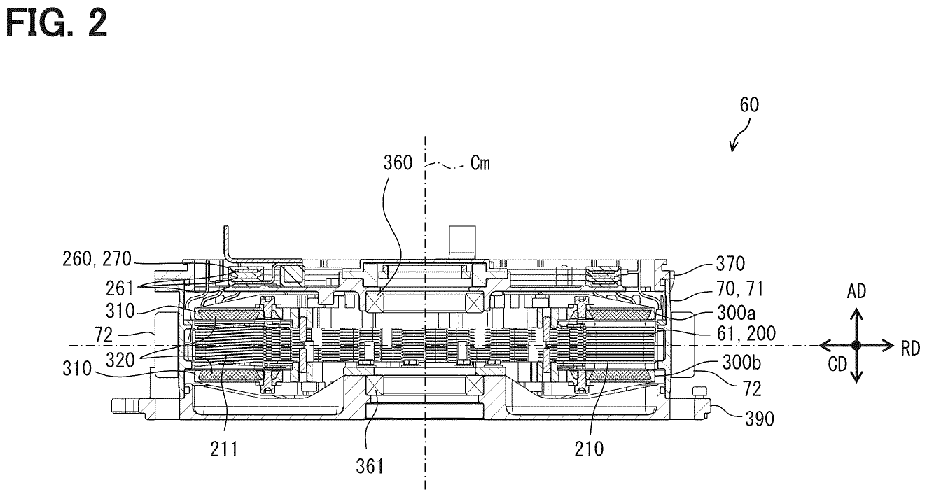

As shown in FIGS. 1 and 2, the motor 61 includes a stator 200, a first rotor 300a, a second rotor 300b, and a motor shaft 340. The stator 200 is a stator. The stator 200 includes a motor coil. The rotors 300a, 300b are rotators. The rotors 300a, 300b rotate relative to the stator 200. The rotors 300a, 300b rotate about the motor axis Cm. The motor axis Cm is a center line of the rotors 300a, 300b. Each of the stator 200 and the motor coil extends in an annular shape in the circumferential direction CD. A center line of the stator 200 coincides with the motor axis Cm.

The motor device 60 is an axial gap-type rotary electric machine. The motor 61 is an axial gap-type motor. In the motor 61, the stator 200 and the rotors 300a, 300b are arranged in the axial direction AD along the motor axis Cm. The motor device 60 is a dual-rotor rotary electric machine. The motor 61 is a dual-rotor motor. The first rotor 300a and the second rotor 300b are arranged in the axial direction AD with the stator 200 interposed therebetween. The stator 200 is provided between two rotors, that is, the first rotor 300a and the second rotor 300b. The stator 200 is located at a position away from the rotors 300a, 300b in the axial direction AD. The motor 61 of the present embodiment may be referred to as a double-axial motor.

The motor shaft 340 supports the rotors 300a, 300b. The motor shaft 340 rotates about the motor axis Cm together with the rotors 300a, 300b. A center line of the motor shaft 340 coincides with the motor axis Cm. The motor shaft 340 connects the rotors 300a, 300b to the propeller 20.

The motor shaft 340 includes a shaft main body 341 and a shaft flange 342. The shaft main body 341 is formed in a tubular shape and extends in the axial direction AD along the motor axis Cm. The shaft flange 342 extends from the shaft main body 341 toward the radially outer side. The shaft flange 342 is fixed to the rotors 300a, 300b. The rotors 300a, 300b are located at positions away from the shaft main body 341 toward the radially outer side.

Each of the rotors 300a, 300b includes magnets 310 and a magnet holder 320. Multiple magnets 310 are arranged in the circumferential direction CD in each of the rotors 300a, 300b. Each of the magnets 310 is a permanent magnet and forms a magnetic field. In each of the rotors 300a, 300b, the magnets 310 generate a magnetic flux. The magnets 310 of the first rotor 300a and the magnets 310 of the second rotor 300b are arranged in the axial direction AD with the stator 200 interposed therebetween. The magnet holder 320 supports the magnets 310. The magnet holder 320 forms an outline of the rotors 300a, 300b as a whole. The magnet holder 320 is fixed to the shaft flange 342.

The motor device 60 includes a first bearing 360 and a second bearing 361. The bearings 360, 361 rotatably support the motor shaft 340. The first bearing 360 and the second bearing 361 are arranged in the axial direction AD with the shaft flange 342 interposed therebetween. The first bearing 360 is fixed to the rear frame 370. The second bearing 361 is fixed to the drive frame 390.

The motor device 60 includes a busbar unit 260. The busbar unit 260 extends in an annular shape in the circumferential direction CD. The busbar units 260 are arranged on the stator 200 in the radial direction RD. The busbar unit 260 includes an electric power busbar 261 and a busbar protection portion 270. Each of the electric power busbar 261 and the busbar protection portion 270 extends in an annular shape in the circumferential direction CD. The electric power busbar 261 is implemented by a busbar member having a conduction property. The electric power busbar 261 forms at least a part of the output line 143. The busbar protection portion 270 is made of a resin material or the like and has an electrical insulation property. The busbar protection portion 270 protects the electric power busbar 261 in a state where the busbar protection portion 270 covers the electric power busbar 261.

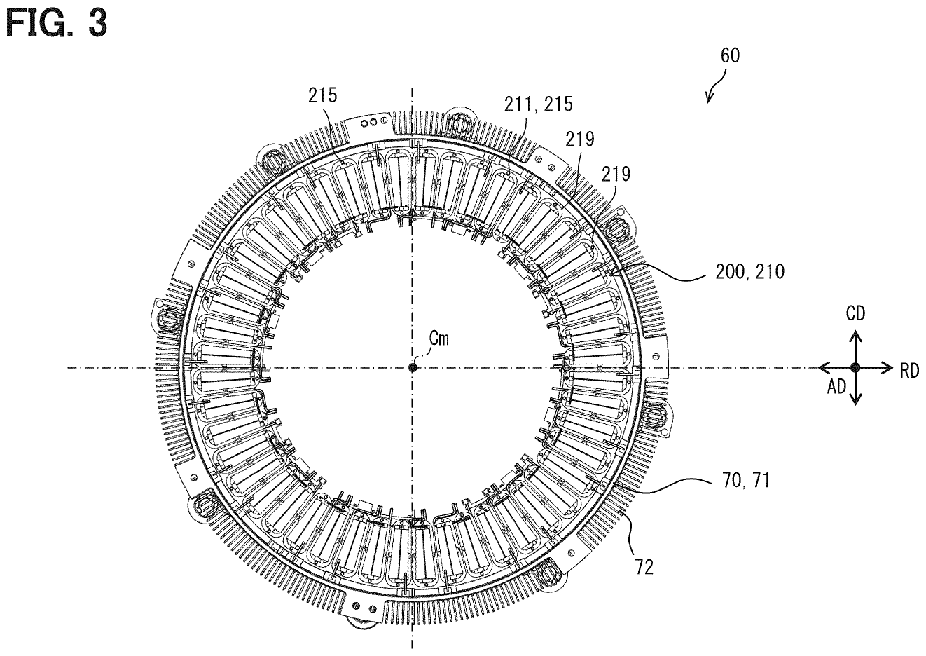

As shown in FIGS. 2 and 3, the stator 200 extends in an annular shape in the circumferential direction CD. The stator 200 includes a coil unit 210 and a coil protection portion 250. Each of the coil unit 210 and the coil protection portion 250 extends in an annular shape in the circumferential direction CD. The coil unit 210 includes coils 211 of multiple phases. The coil protection portion 250 protects at least the coils 211 of the coil unit 210. The coil protection portion 250 covers the coils 211. The coil protection portion 250 is made of a resin material or the like. The coil protection portion 250 has an electrical insulation property. The coil protection portion 250 has a thermal conduction property. In FIGS. 2 and 3, the coil protection portion 250 is not shown. FIG. 2 illustrates a vertical cross-section of the motor device 60 taken along the motor axis Cm. FIG. 3 illustrates a horizontal cross-section of the motor device 60 taken in a direction orthogonal to the motor axis Cm.

The coil protection portion 250 is in contact with the coils 211. The coil protection portion 250 is in contact with the motor housing 70. For example, the coil protection portion 250 is in contact with an inner surface of the motor outer peripheral wall 71. When heat is generated in the coils 211, the heat is easily transferred to the motor housing 70 via the coil protection portion 250. For example, the heat transferred to the motor housing 70 is released to the outside from the motor outer peripheral wall 71 via the motor fins 72.

The coil unit 210 includes coil portions 215. Each of the coil portions 215 is formed in a tubular shape and extends in the axial direction AD. Multiple coil portions 215 are arranged in the circumferential direction CD. The coil portion 215 forms the coil 211. In the coil unit 210, the coils 211 of multiple phases are implemented by the multiple coil portions 215. The coil unit 210 includes coil-portion units 219. Each of the coil-portion units 219 includes multiple coil portions 215. For example, the coil-portion unit 219 includes two coil portions 215. The coil-portion unit 219 forms a coil 211 of one phase among the multiple phases. Multiple coil-portion units 219 are arranged in the circumferential direction CD.

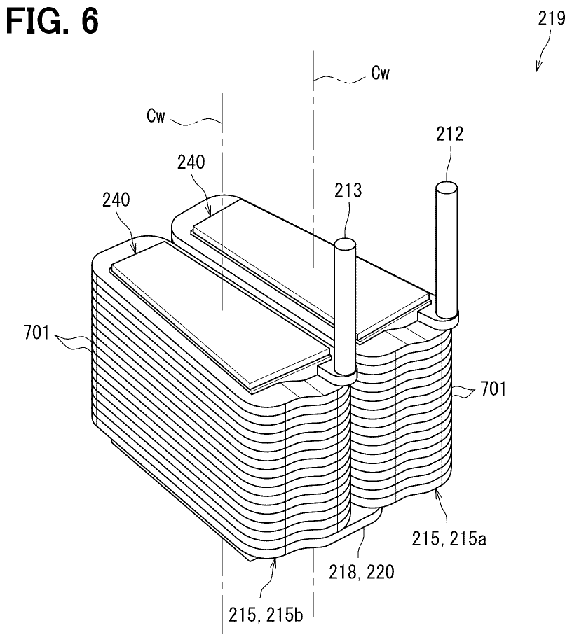

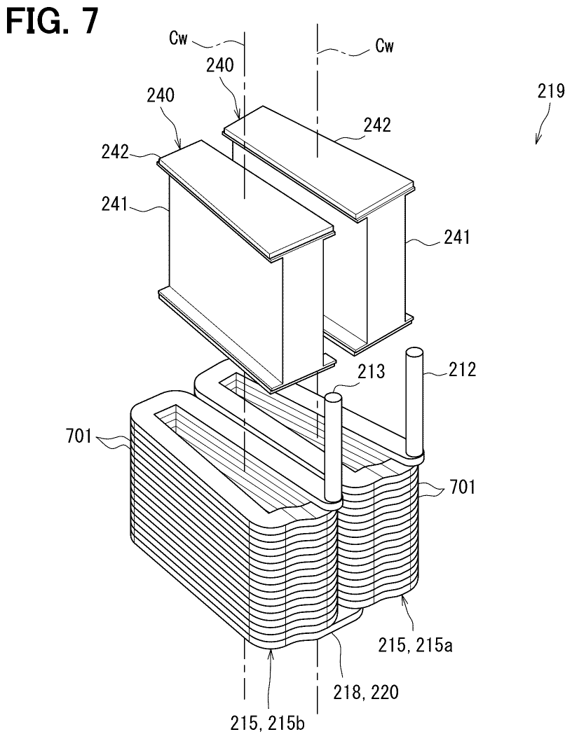

As shown in FIGS. 6 and 7, the coil-portion unit 219 includes a first coil portion 215a and a second coil portion 215b. The first coil portion 215a and the second coil portion 215b are included in the multiple coil portions 215. The first coil portion 215a and the second coil portion 215b are adjacent to each other in the circumferential direction CD.

The coil-portion unit 219 includes an electric power lead-out wire 212, a neutral lead-out wire 213, and a coil connection wire 218. The electric power lead-out wire 212 is drawn out from the first coil portion 215a. The electric power lead-out wire 212 electrically connects the first coil portion 215a and the electric power busbar 261. The electric power lead-out wire 212 is arranged on the first coil portion 215a in the axial direction AD. For example, the electric power lead-out wire 212 extends in the axial direction AD from the first coil portion 215a toward the electric power busbar 261.

The neutral lead-out wire 213 is led out from the second coil portion 215b. The neutral lead-out wire 213 electrically connects the second coil portion 215b and the neutral point 65. The neutral lead-out wire 213 is arranged on the second coil portion 215b in the axial direction AD. For example, the neutral lead-out wire 213 extends in the axial direction AD from the second coil portion 215b toward the same side as the electric power lead-out wire 212.

The coil connection wire 218 electrically connects the first coil portion 215a and the second coil portion 215b. The coil connection wire 218 is provided on a side opposite to the lead-out wires 212, 213 with the coil portions 215a, 215b interposed therebetween in the axial direction AD.

The coil portion 215 is formed of a wound coil wire 220. The coil wire 220 is wound around a winding axis Cw. The winding axis Cw is a center line of the coil portion 215. The winding axis Cw extends in the motor axial direction AD. Regarding the winding axis Cw, an axial direction α, a circumferential direction β, and a radial direction γ are orthogonal to one another. The axial direction α is referred to as a winding axial direction α, the circumferential direction β is referred to as a winding circumferential direction β, and the radial direction γ is referred to as a winding radial direction γ. The winding axial direction α coincides with the motor axial direction AD. In the winding radial direction γ, an outer side may be referred to as the radially outer side or the outer peripheral side, and the inner side may be referred to as the radially inner side or the inner peripheral side.

The coil wire 220 is a plate-shaped electric wire. For example, the coil wire 220 is a flat wire. In the coil portion 215, the coil wire 220 is wound to be stacked in the winding axial direction α. The coil wire 220 extends to be orthogonal to the winding axial direction α. For example, the coil portion 215 is an edgewise coil. In the coil portion 215, the winding circumferential direction β is a winding direction of the coil wire 220. The winding direction is a direction in which the coil wire 220 is wound. The winding axial direction α is a thickness direction of the coil wire 220. The winding radial direction γ is a width direction of the coil wire 220. In the coil portion 215, a cross-section of the coil wire 220 has a flat shape extending in the winding radial direction γ. The cross-section of the coil wire 220 is a horizontal cross-section obtained by cutting the coil wire 220 in the winding circumferential direction β.

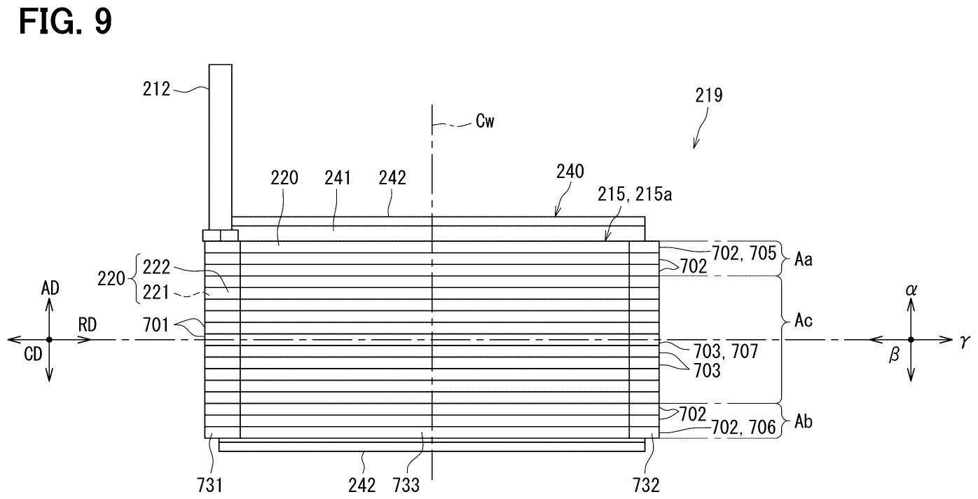

As shown in FIGS. 9 to 12, the coil wire 220 includes a coil conductor 221 and a coil coating 222. The coil conductor 221 is made of a conductive material such as copper, and has a conduction property. The coil conductor 221 is formed in a plate shape and extends to be orthogonal to the winding axial direction α. The coil conductor 221 corresponds to a conductor. The coil coating 222 coats the coil conductor 221. The coil coating 222 is made of a resin material, a rubber material, or the like, and has an electrical insulation property.

As shown in FIGS. 6 and 7, the coil portion 215 includes coil annular portions 701. Multiple coil annular portions 701 are stacked in the winding axial direction α. The multiple coil annular portions 701 are connected to each other. The coil annular portions 701 are formed by the coil wire 220. Each of the coil annular portions 701 has a flat shape extending in the motor radial direction RD. The coil annular portion 701 has longitudinal portions extending in the motor radial direction RD and short portions extending in the motor circumferential direction CD.

The coil annular portion 701 includes an annular conductor 701a and an annular coating 701b. Each of the annular conductor 701a and the annular coating 701b extends in an annular shape in the winding circumferential direction β. The annular conductor 701a is implemented by the coil conductor 221. The annular coating 701b is implemented by the coil coating 222. In two coil annular portions 701 adjacent to each other in the winding axial direction α, the annular coatings 701b are in contact with each other.

As shown in FIG. 9, the multiple coil annular portions 701 include a lead-out annular portion 705, a connection annular portion 706, and a central annular portion 707. The multiple coil annular portions 701 include a pair of coil annular portions 701 provided on outermost sides in the winding axial direction α. One of the pair of coil annular portions 701 is the lead-out annular portion 705, and the other is the connection annular portion 706. In the coil portion 215, the lead-out wires 212, 213 extend from the lead-out annular portion 705. For example, in the first coil portion 215a, the electric power lead-out wire 212 extends from the lead-out annular portion 705. In the second coil portion 215b, the neutral lead-out wire 213 extends from the lead-out annular portion 705.

In the coil portion 215, the coil connection wire 218 extends from the connection annular portion 706. For example, the coil connection wire 218 connects the connection annular portion 706 of the first coil portion 215a and the connection annular portion 706 of the second coil portion 215b. The central annular portion 707 is the coil annular portion 701 disposed at a center of the coil portion 215 in the winding axial direction α. The number of central annular portion 707 included in the multiple coil annular portions 701 may be one or two.

The lead-out annular portion 705 is disposed closest to the first rotor 300a among the multiple coil annular portions 701 in the winding axial direction α. That is, the lead-out annular portion 705 is located at a position closest to the first rotor 300a. The connection annular portion 706 is disposed closest to the second rotor 300b among the multiple coil annular portions 701 in the winding axial direction α. That is, the connection annular portion 706 is located at a position closest to the second rotor 300b. The lead-out annular portion 705 and the connection annular portion 706 correspond to a closest annular portion.

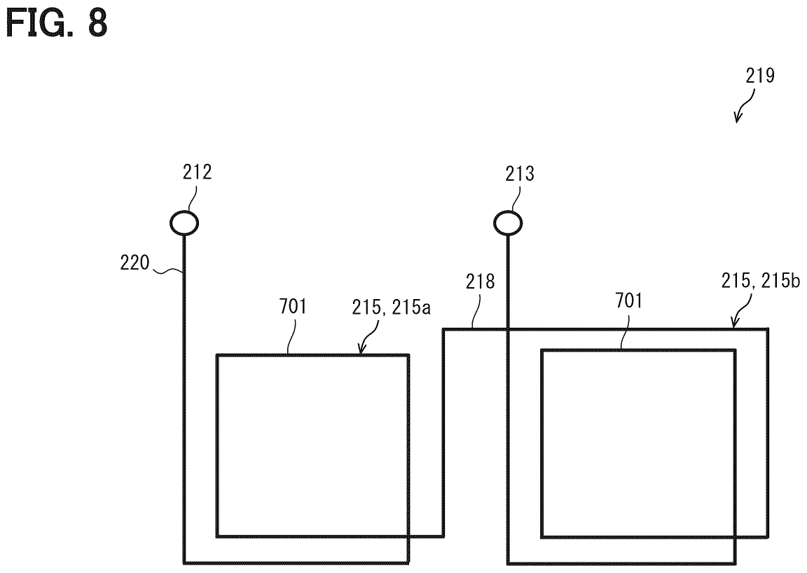

As shown in FIG. 8, the winding direction of the coil wire 220 is reversed between the first coil portion 215a and the second coil portion 215b. For example, when the coil portions 215a, 215b are viewed from a lead-out annular portion 705 side, the coil wire 220 is wound counterclockwise in the first coil portion 215a. In the second coil portion 215b, the coil wire 220 is wound clockwise.

A lead-out region Aa, a connection region Ab, and an intermediate region Ac are set for the coil portion 215. In the coil portion 215, each of the multiple coil annular portions 701 is provided in one of the regions Aa, Ab, or Ac. The regions Aa, Ab, and Ac are obtained by dividing the coil portion 215 in the winding axial direction a. In the winding axial direction α, the lead-out region Aa and the connection region Ab are arranged in the winding axial direction α with the intermediate region Ac interposed therebetween. The lead-out region Aa is provided on a side of the lead-out wires 212, 213 facing the intermediate region Ac. The connection region Ab is provided on a side of the coil connection wire 218 facing the intermediate region Ac.

In each of the regions Aa, Ab, and Ac, at least one coil annular portion 701 is provided. For example, multiple coil annular portions 701 are provided in each of the regions Aa, Ab, and Ac. At least the lead-out annular portion 705 is provided in the lead-out region Aa. At least the connection annular portion 706 is provided in the connection region Ab. The central annular portion 707 is provided in the intermediate region Ac.

The stator 200 includes bobbins 240. The coil portion 215 is attached to each of the bobbins 240. Each of the bobbins 240 is made of a resin material or the like and has an electrical insulation property. The bobbin 240 includes a bobbin trunk portion 241 and bobbin flanges 242. The bobbin trunk portion 241 is formed in a columnar shape and extends in the winding axial direction α. Each of the bobbin flanges 242 extends from the bobbin trunk portion 241 toward the outer peripheral side. A pair of the bobbin flanges 242 are arranged in the winding axial direction α with the bobbin trunk portion 241 interposed therebetween. The coil portion 215 is wound around the bobbin trunk portion 241 between the pair of bobbin flanges 242.

The stator 200 includes a core (not shown). The core is provided on the bobbin 240. For example, the core is incorporated in the bobbin 240. The coil portion 215 is wound around the core via the bobbin 240.

In the coil portion 215, the number of coil annular portions 701 in the lead-out region Aa and the number of coil annular portions 701 in the connection region Ab are both smaller than the number of coil annular portions 701 in the intermediate region Ac. The number of coil annular portions 701 in the lead-out region Aa is the same as the number of coil annular portions 701 in the connection region Ab. A sum of the number of coil annular portions 701 in the lead-out region Aa and the number of coil annular portions 701 in the connection region Ab is smaller than the number of coil annular portions 701 in the intermediate region Ac. The sum may be equal to or greater than the number of coil annular portions 701 in the intermediate region Ac.

As shown in FIGS. 9, 10, and 13, the coil portion 215 includes outer-wall-side peripheral portions 731, shaft-side peripheral portions 732, and facing peripheral portions 733. The peripheral portions 731, 732, and 733 extend in the winding circumferential direction β. The peripheral portions 731, 732, and 733 are arranged in the winding circumferential direction β. Each of the peripheral portions 731, 732, and 733 is a part of the coil wire 220.

The outer-wall-side peripheral portions 731 form an outer peripheral end of the coil portion 215 in the motor radial direction RD. The outer-wall-side peripheral portions 731 extend in the motor circumferential direction CD along the inner surface of the motor outer peripheral wall 71. The shaft-side peripheral portions 732 form an inner peripheral end of the coil portion 215 in the motor radial direction RD. The shaft-side peripheral portions 732 extend in the motor circumferential direction CD along an outer surface of the shaft main body 341. The outer-wall-side peripheral portions 731 and the shaft-side peripheral portions 732 correspond to a circumferential extension portion.

The facing peripheral portions 733 are provided in pair to be arranged in the motor circumferential direction CD. The pair of facing peripheral portions 733 face each other with an inner space of the coil portion 215 interposed therebetween. For example, the pair of facing peripheral portions 733 face each other with the bobbins 240 interposed therebetween. Each of the facing peripheral portions 733 forms a side end of the coil portion 215 in the motor circumferential direction CD. The facing peripheral portion 733 extends in the motor radial direction RD. The facing peripheral portion 733 connects the outer-wall-side peripheral portion 731 and the shaft-side peripheral portion 732. The facing peripheral portion 733 corresponds to a radial extension portion.

The coil portion 215 has a substantially rectangular shape in a plan view. For example, the coil portion 215 has a substantially trapezoidal shape in a plan view. Each of the outer-wall-side peripheral portion 731 and the shaft-side peripheral portion 732 extends substantially straight in the motor circumferential direction CD. The outer-wall-side peripheral portion 731 and the shaft-side peripheral portion 732 are provided parallel to each other. Each of the pair of facing peripheral portions 733 extends substantially straight in the motor radial direction RD. The pair of facing peripheral portions 733 are inclined to each other.

As shown in FIG. 9, the multiple coil annular portions 701 include conductor-divided annular portions 702 and conductor-integrated annular portions 703. In each of the conductor-divided annular portions 702, at least a part of the annular conductor 701a is divided into multiple parts in a direction orthogonal to the winding circumferential direction β. In each of the conductor-integrated annular portions 703, the annular conductor 701a does not branch. Among the multiple coil annular portions 701, at least the lead-out annular portion 705 is the conductor-divided annular portion 702. For example, all of the coil annular portions 701 provided in the lead-out region Aa are the conductor-divided annular portions 702. Among the multiple coil annular portions 701, at least the connection annular portion 706 is the conductor-divided annular portion 702. For example, all of the coil annular portions 701 provided in the connection region Ab are the conductor-divided annular portions 702. Among the multiple coil annular portions 701, at least the central annular portion 707 is the conductor-integrated annular portions 703. For example, all of the coil annular portions 701 provided in the intermediate region Ac are the conductor-integrated annular portion 703.

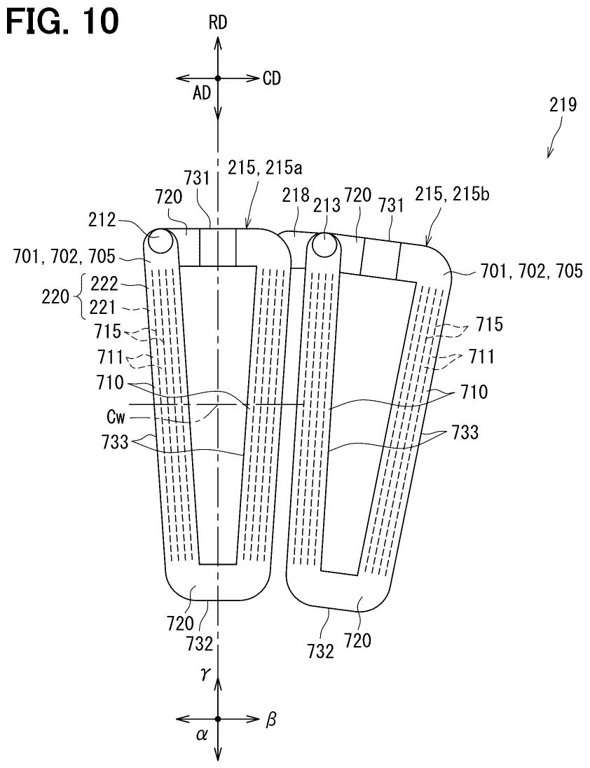

As shown in FIGS. 10 to 12, the conductor-divided annular portion 702 includes conductor-divided portions 710 and conductor-integrated portions 720. The conductor-divided portions 710 and the conductor-integrated portions 720 extend in the winding circumferential direction β. The conductor-divided portions 710 and the conductor-integrated portions 720 are arranged in the winding circumferential direction β.

In each of the conductor-divided portions 710, the annular conductor 701a is divided into multiple parts in a direction orthogonal to the winding circumferential direction β. For example, in the conductor-divided portion 710, the annular conductor 701a is divided into multiple parts in the winding radial direction γ. In each of the conductor-integrated portions 720, the annular conductor 701a is not divided into multiple parts.

At least a part of the conductor-divided portion 710 is included in each of the pair of facing peripheral portions 733. The conductor-divided portion 710 extends in the motor radial direction RD to span the outer-wall-side peripheral portion 731 and the shaft-side peripheral portion 732 in the facing peripheral portion 733. At least a part of the conductor-integrated portion 720 is included in each of the outer-wall-side peripheral portion 731 and the shaft-side peripheral portion 732. The conductor-integrated portion 720 extends in the motor circumferential direction CD to span the pair of facing peripheral portions 733 in each of the outer-wall-side peripheral portion 731 and the shaft-side peripheral portion 732.

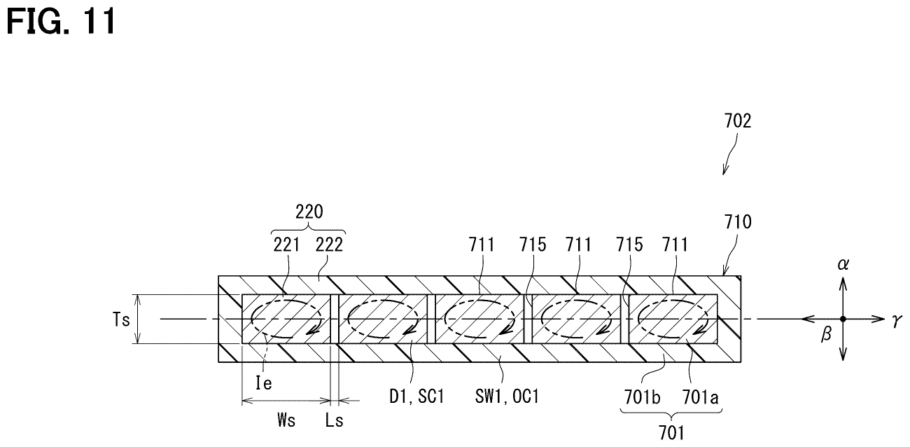

As shown in FIGS. 10 and 11, the conductor-divided portion 710 includes divided conductors 711 and dividing gaps 715 in addition to the annular coating 701b. Multiple divided conductors 711 are arranged in the winding radial direction γ. Each of the divided conductors 711 extends in the winding circumferential direction β. For example, each of the divided conductors 711 extends substantially straight in the motor radial direction RD. The multiple divided conductors 711 are provided parallel to each other. The multiple divided conductors 711 are included in the annular conductor 701a. In the conductor-divided portion 710, the multiple divided conductors 711 are formed by dividing the annular conductor 701a into multiple parts in the winding radial direction γ. In the coil portion 215, the conductor-divided annular portion 702 corresponds to a conductor-arranged annular portion, and the conductor-divided portion 710 corresponds to a conductor-arranged portion. The divided conductor 711 corresponds to an arranged conductor and a width-direction arranged conductor.

Each of the dividing gaps 715 is a gap between two adjacent divided conductors 711. The two divided conductors 711 adjacent to each other in the winding radial direction γ are located at positions away from each other in the winding radial direction γ with the dividing gap 715 interposed therebetween. The dividing gap 715 is provided between two adjacent divided conductors 711 to separate the divided conductors 711 from each other. The dividing gaps 715 extend in the winding circumferential direction β along the divided conductors 711. The dividing gap 715 corresponds to an interposed portion. The dividing gap 715 may be referred to as an interval or a slit. Multiple dividing gaps 715 are arranged in the winding radial direction γ. A gas such as air exists in the dividing gap 715. A thermal conduction property of the dividing gap 715 is lower than a thermal conduction property of the divided conductor 711. A conduction property of the dividing gap 715 is lower than a conduction property of the divided conductor 711.

In the conductor-divided portion 710, a distance Ls between two adjacent divided conductors 711 is smaller than a thickness Ts of the divided conductor 711 in the winding axial direction α. The distance Ls is smaller than a width Ws of the divided conductor 711 in the winding radial direction γ. For example, a cross-section of the divided conductor 711 is flattened to extend in the winding radial direction γ. In the divided conductor 711, the width Ws is larger than the thickness Ts.

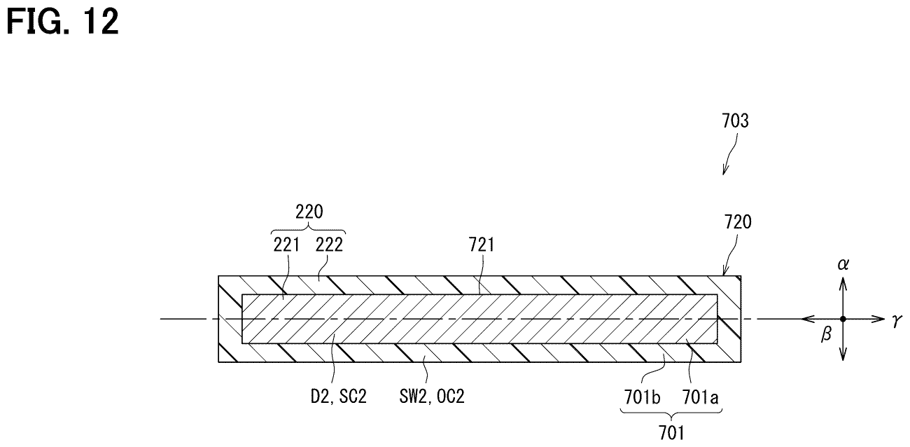

As shown in FIGS. 10 and 12, the conductor-integrated portion 720 includes an integrated conductor 721 in addition to the annular coating 701b. The integrated conductor 721 extends in the winding circumferential direction β. In the conductor-integrated portion 720, one integrated conductor 721 is formed by not dividing the annular conductor 701a into multiple parts. In the conductor-divided annular portion 702, the conductor-divided portion 710 extends from the conductor-integrated portion 720 in the winding circumferential direction β. At a boundary portion between the conductor-divided portion 710 and the conductor-integrated portion 720, the integrated conductor 721 extends in the winding radial direction γ to span multiple divided conductors 711. The integrated conductor 721 connects the multiple divided conductors 711.

In the coil annular portion 701, a difference in a conductor ratio occurs depending on the presence or absence of the dividing gap 715. The conductor ratio is a proportion of the annular conductor 701a in cross-section of the coil annular portion 701. For example, the conductor ratio is a proportion of a cross-sectional area of the annular conductor 701a in cross-sectional area of the coil annular portion 701.

In FIGS. 11 and 12, a divided-conductor ratio OC1 of the conductor-divided portion 710 is smaller than an integrated-conductor ratio OC2 of the conductor-integrated portion 720. The divided-conductor ratio OC1 is a proportion of the multiple divided conductors 711 in a cross-section of the conductor-divided portion 710. For example, the divided-conductor ratio OC1 is a proportion of a total cross-sectional area SC1 of the multiple divided conductors 711 in a cross-sectional area SW1 of the conductor-divided portion 710. The cross-sectional area SW1 includes a cross-sectional area of the coil coating 222, cross-sectional areas of the divided conductors 711, and cross-sectional areas of the dividing gaps 715. The total cross-sectional area SC1 is a sum of cross-sectional areas of the multiple divided conductors 711. The total cross-sectional area SC1 does not include the cross-sectional areas of the dividing gaps 715.

The integrated-conductor ratio OC2 is a proportion of the integrated conductor 721 in a cross-section of the conductor-integrated portion 720. For example, the integrated-conductor ratio OC2 is a proportion of a cross-sectional area SC2 of the integrated conductor 721 in a cross-sectional area SW2 of the conductor-integrated portion 720. The cross-sectional area SW2 includes the cross-sectional area of the coil coating 222 and a cross-sectional area of the integrated conductor 721.

For example, the cross-sectional areas SW1, SW2 of the conductor-divided portion 710 and the conductor-integrated portion 720 are the same. Meanwhile, the total cross-sectional area SC1 of the multiple divided conductors 711 is smaller than the cross-sectional area SC2 of the integrated conductor 721 by the cross-sectional areas of the dividing gaps 715. Therefore, the divided-conductor ratio OC1 is smaller than the integrated-conductor ratio OC2 by an amount corresponding to the dividing gaps 715 in the conductor-divided portion 710. The conductor-divided portion 710 corresponds to a first occupancy portion, and the conductor-integrated portion 720 corresponds to a second occupancy portion. The divided-conductor ratio OC1 corresponds to a first conductor ratio, and the integrated-conductor ratio OC2 corresponds to a second conductor ratio.

A division density D1 of the divided conductor 711 and an integration density D2 of the integrated conductor 721 are the same. The division density D1 is a volume density of the divided conductors 711. The division density D1 is a mass per unit volume of the divided conductor 711. The integration density D2 is a volume density of the integrated conductor 721. The integration density D2 is a mass per unit volume of the integrated conductor 721.

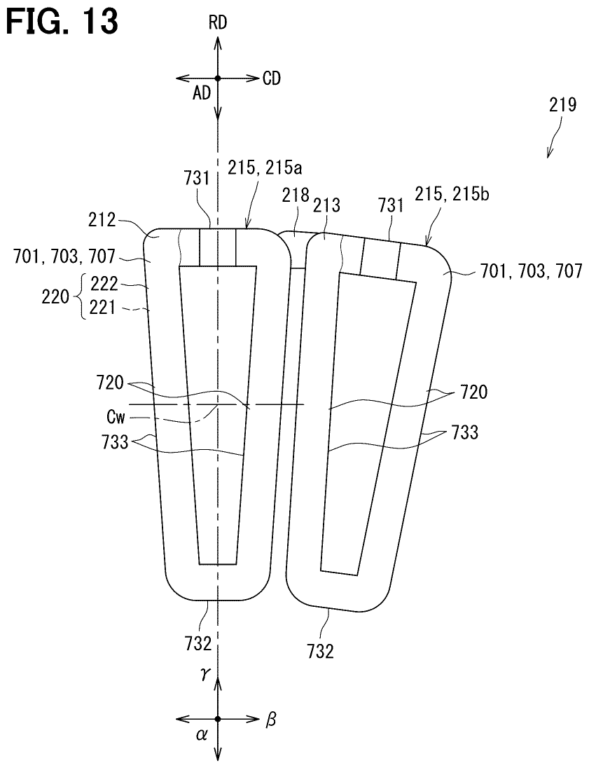

As shown in FIG. 13, the conductor-integrated annular portion 703 includes the conductor-integrated portion 720, but does not include the conductor-divided portion 710. In the conductor-integrated annular portion 703, the conductor-integrated portion 720 extends in an annular shape in the winding circumferential direction β. For example, in the conductor-integrated annular portion 703, the integrated conductor 721 extends in an annular shape in the winding circumferential direction β.

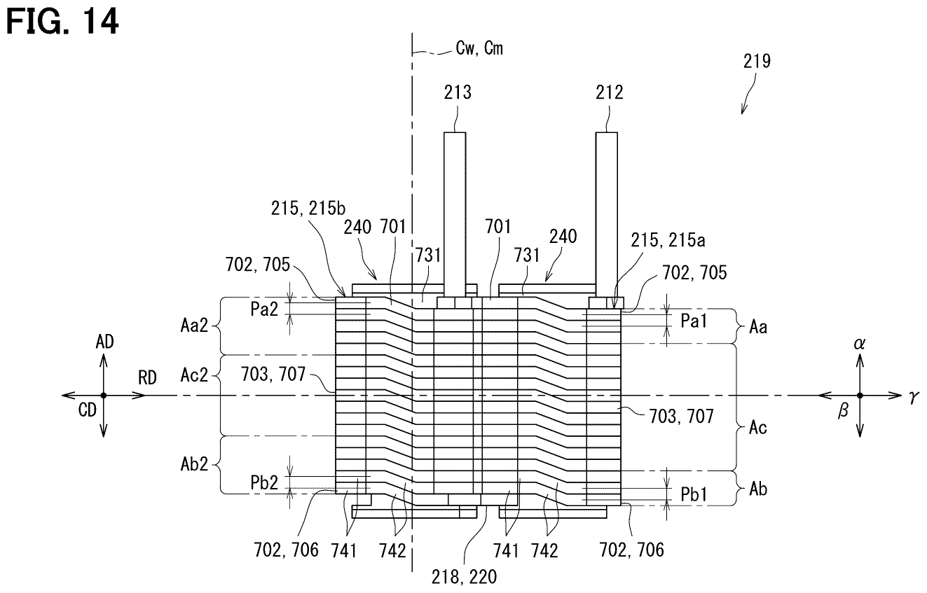

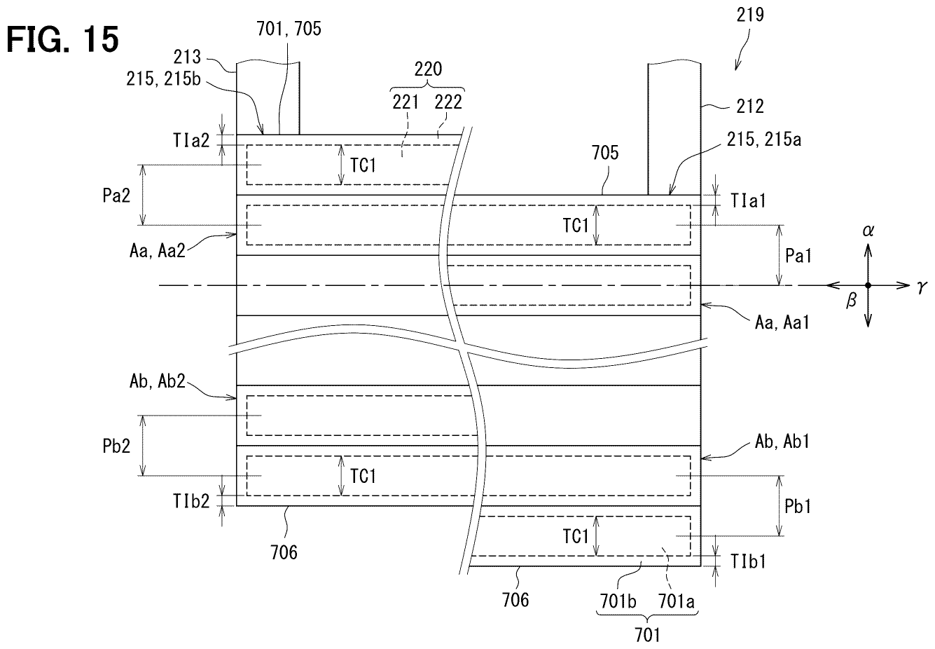

As shown in FIGS. 14 and 15, in the coil-portion unit 219, the lead-out region Aa, the connection region Ab, and the intermediate region Ac are set for each of the first coil portion 215a and the second coil portion 215b. In the first coil portion 215a, a first lead-out region Aa1, a first connection region Ab1, and a first intermediate region Ac1 are set as the lead-out region Aa, the connection region Ab, and the intermediate region Ac. A second lead-out region Aa2, a second connection region Ab2, and a second intermediate region Ac2 are set for the second coil portion 215b.

In the coil portion 215, a pitch of the annular conductor 701a is not uniform. The pitch is an interval between two annular conductors 701a adjacent to each other in the winding axial direction α. For example, the pitch is a distance between centers of two adjacent annular conductors 701a.

In the first coil portion 215a, a first lead-out pitch Pal in the first lead-out region Aa1 and a first connection pitch Pb1 in the first connection region Ab1 are different from each other. For example, the first lead-out pitch Pa1 is larger than the first connection pitch Pb1. That is, a relationship of Pa1>Pb1 is established. The first lead-out pitch Pa1 is an interval between two annular conductors 701a adjacent to each other in the winding axial direction α in the first lead-out region Aa1. The first connection pitch Pb1 is an interval between two annular conductors 701a adjacent to each other in the winding axial direction α in the first connection region Ab1.

In the second coil portion 215b, a second lead-out pitch Pa2 in the second lead-out region Aa2 and a second connection pitch Pb2 in the second connection region Ab2 are different from each other. For example, the second connection pitch Pb2 is larger than the second lead-out pitch Pa2. That is, a relationship of Pb2>Pa2 is established. The second lead-out pitch Pa2 is an interval between two annular conductors 701a adjacent to each other in the winding axial direction α in the second lead-out region Aa2. The second connection pitch Pb2 is an interval between two annular conductors 701a adjacent to each other in the winding axial direction α in the second connection region Ab2.

In the coil-portion unit 219, the pitch of the annular conductor 701a is not uniform between the first coil portion 215a and the second coil portion 215b. For example, while the first connection pitch Pb1 and the second connection pitch Pb2 are the same, the first lead-out pitch Pa1 is larger than the second lead-out pitch Pa2. That is, a relationship of Pa1>Pb1=Pb2>Pa2 is established.

In the coil portion 215, a thickness of the annular coating 701b is not uniform. Meanwhile, in the coil portion 215, a thickness of the annular conductor 701a is uniform. In this way, in the coil portion 215, since the thickness of the annular coating 701b is not uniform, the pitch of the annular conductor 701a is not uniform. The thickness of the annular conductor 701a and the thickness of the annular coating 701b are a thickness in the winding axial direction α.

In the coil portion 215, the pitch of the annular conductor 701a in the intermediate region Ac is the same as the pitch of the annular conductor 701a in the connection region Ab. For example, in the first coil portion 215a, a first intermediate pitch in the first intermediate region Ac1 is the same as the first connection pitch Pb1. The first intermediate pitch is an interval between two annular conductors 701a adjacent to each other in the winding axial direction α in the first intermediate region Ac1. In the second coil portion 215b, a second intermediate pitch in the second intermediate region Ac2 is the same as the second connection pitch Pb2. The second intermediate pitch is an interval between two annular conductors 701a adjacent to each other in the winding axial direction α in the second intermediate region Ac2.

As shown in FIG. 15, in the first coil portion 215a, a first lead-out coating thickness TIa1 in the first lead-out region Aa1 and a first connection coating thickness TIb1 in the first connection region Ab1 are different from each other. For example, the first lead-out coating thickness TIa1 is larger than the first connection coating thickness TIb1. That is, a relationship of TIa1>TIb1 is established. The first lead-out coating thickness TIa1 is the thickness of the annular coating 701b in the first lead-out region Aa1. The first connection coating thickness TIb1 is the thickness of the annular coating 701b in the first connection region Ab1. In the first coil portion 215a, even when the thickness of the annular conductor 701a is the same in the first lead-out region Aa1 and the first connection region Ab1, the first lead-out pitch Pa1 is larger than the first connection pitch Pb1 since the first lead-out coating thickness TIa1 is larger than the first connection coating thickness TIb1. The thickness of the annular conductor 701a is assumed to be a lane-portion conductor thickness TC1 to be described later.

In the second coil portion 215b, a second lead-out coating thickness TIa2 in the second lead-out region Aa2 and a second connection coating thickness TIb2 in the second connection region Ab2 are different from each other. For example, the second lead-out coating thickness TIa2 is smaller than the second connection coating thickness TIb2. That is, a relationship of TIa2<TIb2 is established. The second lead-out coating thickness TIa2 is the thickness of the annular coating 701b in the second lead-out region Aa2. The second connection coating thickness TIb2 is the thickness of the annular coating 701b in the second connection region Ab2. In the second coil portion 215b, even when the thickness of the annular conductor 701a is the same in the second lead-out region Aa2 and the second connection region Ab2, the second lead-out pitch Pa2 is smaller than the second connection pitch Pb2 since the second lead-out coating thickness TIa2 is smaller than the second connection coating thickness TIb2.

In the coil-portion unit 219, the thickness of the annular coating 701b is not uniform between the first coil portion 215a and the second coil portion 215b. For example, while the first connection coating thickness TIb1 and the second connection coating thickness TIb2 are the same, the first lead-out coating thickness TIa1 is larger than the second lead-out coating thickness TIa2. That is, a relationship of TIa1>TIb1=TIb2>TIa2 is established.

In the coil portion 215, the thickness of the annular coating 701b in the intermediate region Ac is the same as the thickness of the annular coating 701b in the connection region Ab. For example, in the first coil portion 215a, a first intermediate coating thickness in the first intermediate region Ac1 is the same as the first connection coating thickness TIb1. The first intermediate coating thickness is the thickness of the annular coating 701b in the first intermediate region Ac1. In the second coil portion 215b, a second intermediate coating thickness in the second intermediate region Ac2 is the same as the second connection coating thickness TIb2. The second intermediate coating thickness is the thickness of the annular coating 701b in the second intermediate region Ac2.

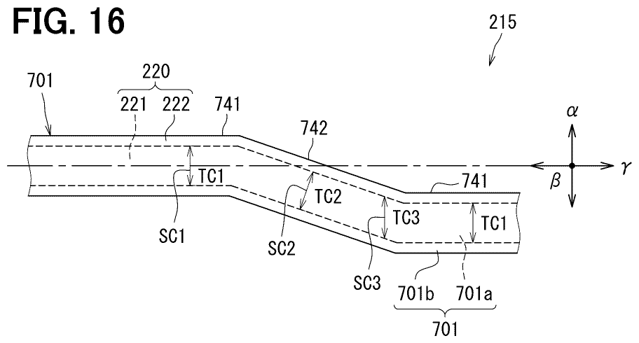

As shown in FIGS. 14 and 16, the coil annular portion 701 includes a lane portion 741 and a lane change portion 742. The lane portion 741 and the lane change portion 742 extend in the winding circumferential direction β. The lane portion 741 and the lane change portion 742 are arranged in the winding circumferential direction βwhile being connected to each other. Each of the lane portion 741 and the lane change portion 742 is a part of the coil wire 220.

The lane portion 741 extends in the winding circumferential direction β so as to be orthogonal to the winding axis Cw. The lane change portion 742 extends in the winding circumferential direction β so as to be inclined with respect to the lane portion 741. The lane change portion 742 corresponds to a lane inclination portion. In two coil annular portions 701 adjacent to each other in the winding axial direction α, the lane change portion 742 of one coil annular portion 701 connects the lane portion 741 of the one coil annular portion 701 and the lane portion 741 of the other coil annular portion 701. The lane change portion 742 spans the lane portion 741 of the one coil annular portion 701 and the lane portion 741 of the other coil annular portion 701 in the winding axial direction α.

In multiple coil annular portions 701 stacked in the winding axial direction α, the multiple lane portions 741 are stacked in the winding axial direction α, and the multiple lane change portions 742 are stacked in the winding axial direction α. The multiple lane portions 741 are provided in parallel. Two lane portions 741 adjacent to each other in the winding axial direction α are in contact with each other. The multiple lane change portions 742 are provided in parallel. Two lane change portions 742 adjacent to each other in the winding axial direction α are in contact with each other.

In the coil portion 215, a thicknesses of the lane portion 741 and a thicknesses of the lane change portion 742 are set such that no gap is generated between two coil annular portions 701 adjacent to each other in the winding axial direction α. For example, the thickness of the lane portion 741 is larger than the thickness of the lane change portion 742. The thickness of the lane portion 741 is a thickness of the lane portion 741 in a lane cross-section orthogonal to a direction in which the lane portion 741 extends. The thickness of the lane change portion 742 is a thickness of the lane change portion 742 in a change cross-section orthogonal to a direction in which the lane change portion 742 extends.

In the coil annular portion 701, the thickness of the annular coating 701b is the same between the lane portion 741 and the lane change portion 742. Meanwhile, the thickness of the annular conductor 701a is different between the lane portion 741 and the lane change portion 742.

As shown in FIG. 16, a lane-change-portion conductor thickness TC2 in the lane change portion 742 is smaller than a lane-portion conductor thickness TC1 in the lane portion 741. The lane-portion conductor thickness TC1 is the thickness of the annular conductor 701a in the lane cross-section. The lane-change-portion conductor thickness TC2 is the thickness of the annular conductor 701a in the change cross-section. In this way, in the coil portion 215, even when the thickness of the annular coating 701b is the same between the lane portion 741 and the lane change portion 742, a gap is less likely to be generated between two coil annular portions 701 adjacent to each other in the winding axial direction α since the lane-change-portion conductor thickness TC2 is smaller than the lane-portion conductor thickness TC1.

In the coil annular portion 701, a lane-change-portion conductor height TC3 in the lane change portion 742 is larger than the lane-change-portion conductor thickness TC2. For example, the lane-change-portion conductor height TC3 has the same value as the lane-portion conductor thickness TC1. The lane-change-portion conductor height TC3 is a height of the annular conductor 701a in an axial cross-section extending parallel to the winding axis Cw. That is, the lane-change-portion conductor height TC3 is the height of the annular conductor 701a in the winding axial direction α.

One coil annular portion 701 includes one lane portion 741 and one lane change portion 742. The coil annular portion 701 is lane-changed at all of the outer-wall-side peripheral portion 731, the shaft-side peripheral portion 732, and the facing peripheral portions 733. For example, as shown in FIG. 14, the coil annular portion 701 is lane-changes at the outer-wall-side peripheral portion 731. In the coil annular portion 701, the lane change portion 742 is provided on the outer-wall-side peripheral portion 731, but is not provided on the shaft-side peripheral portion 732 and the facing peripheral portions 733. The lane portion 741 is provided to span the pair of facing peripheral portions 733 with the shaft-side peripheral portion 732 interposed therebetween. A part of the lane portion 741 may be provided on the outer-wall-side peripheral portion 731.

As shown in FIG. 11, in the coil portion 215, an eddy current Ie may be generated in the coil conductor 221. The eddy current Ie flows spirally along a cross-section of the coil conductor 221 so as to be orthogonal to the winding circumferential direction β. The eddy current Ie is generated when the magnetic flux generated in the rotors 300a and 300b interlinks with the coil conductor 221, for example. In the coil portion 215, the eddy current Ie tends to increase as a cross-section of the coil conductor 221 increases. In the coil portion 215, an AC copper loss may increase as the eddy current Ie increases. The AC copper loss includes an eddy current loss caused by the eddy current Ie.

Meanwhile, according to the present embodiment, multiple divided conductors 711 are arranged in the conductor-divided portion 710. In the configuration, a cross-section of the divided conductor 711 can be reduced. Two divided conductors 711 adjacent to each other in a direction orthogonal to the winding circumferential direction β are provided at positions away from each other. In the configuration, even if the eddy current Ie is generated in the conductor-divided portion 710, the eddy current Ie individually flows in each of the multiple divided conductors 711. In this way, since a range in which the eddy current Ie flows is limited to a narrow range in the cross-section of the divided conductor 711, the eddy current Ie is unlikely to increase. Accordingly, the divided conductor 711 can limit an increase in the eddy current loss and the AC copper loss caused by the increase in the eddy current Ie.

In the coil portion 215, the plate-shaped coil wire 220 is wound to be stacked in the motor axial direction AD. In the configuration, since a space factor of the coil conductor 221 in the coil portion 215 tends to increase, an increase in the DC copper loss in the coil portion 215 can be limited. That is, in the conductor-divided portion 710, even when the coil conductor 221 is divided into the multiple divided conductors 711, an overall shape of the coil conductor 221, which is called a plate shape, is maintained. Therefore, in the conductor-divided portion 710, since the cross-section of the coil conductor 221 is increased, an electric resistance of the coil conductor 221 is also unlikely to increase. Accordingly, in the conductor-divided portion 710, the increase in the DC copper loss can also be limited.

As described above, in the motor 61, a loss such as the DC copper loss and the AC copper loss in the coil portion 215 can be reduced.

According to the present embodiment, the multiple divided conductors 711 are arranged in the winding radial direction γ. In the configuration, the multiple divided conductors 711 are formed by dividing the plate-shaped coil conductor 221, which extends in the winding radial direction γ, in the winding radial direction γ. Therefore, contact between the multiple divided conductors 711 caused by the fact that the shape of the divided conductor 711 does not need to be complicated is less likely to occur. Accordingly, for example, a large eddy current Ie flowing through a contact portion between two adjacent divided conductors 711 can be limited.

In the coil portion 215, the coil annular portion 701 in which the eddy current Ie is likely to be generated and the coil annular portion 701 in which the eddy current Ie is less likely to be generated exist. For example, among the multiple coil annular portions 701, the closer the coil annular portion 701 is to the rotors 300a, 300b, the more likely the eddy current Ie is to be generated. In the coil portion 215, the eddy current Ie is most likely to be generated in the lead-out annular portion 705 and the connection annular portion 706. In the lead-out annular portion 705 and the connection annular portion 706, the eddy current Ie is likely to be generated due to the fact that the magnetic flux from the rotors 300a, 300b is likely to interlink.

Meanwhile, according to the present embodiment, at least the lead-out annular portion 705 and the connection annular portion 706 of the multiple coil annular portions 701 in the coil portion 215 are the conductor-divided annular portions 702. In the configuration, the conductor-divided portion 710 can limit the generation of the eddy current Ie in the lead-out annular portion 705 and the connection annular portion 706 in which the eddy current Ie is most likely to be generated in the coil portion 215. In the conductor-divided portion 710, even if the magnetic flux from the rotors 300a, 300b interlinks with the multiple divided conductors 711, the eddy current Ie is less likely to be generated because the divided conductors 711 are reduced in size. In this way, the limitation of the eddy current Ie in the lead-out annular portion 705 and the connection annular portion 706 is effective in reducing the AC copper loss in the coil portion 215.

In the coil portion 215, in addition to the lead-out annular portion 705 and the connection annular portion 706, the eddy current Ie is also likely to be generated in the coil annular portions 701 in the lead-out region Aa and the connection region Ab. Meanwhile, in the present embodiment, the coil annular portions 701 in the lead-out region Aa and the connection region Ab are the conductor-divided annular portions 702. Therefore, the eddy current Ie can be reduced by the conductor-divided portions 710 in the coil annular portions 701 in the lead-out region Aa and the connection region Ab.

In the coil portion 215, the farther the coil annular portion 701 is from the rotors 300a, 300b, the less likely the eddy current Ie is to be generated. In the coil portion 215, the eddy current Ie is least likely to be generated in the central annular portion 707. In the central annular portion 707, the eddy current Ie is less likely to be generated due to the fact that the magnetic flux from the rotors 300a, 300b is less likely to interlink. That is, in the coil annular portion 701 such as the central annular portion 707 on a side opposite to the rotors 300a, 300b with the lead-out annular portion 705 and the connection annular portion 706 interposed therebetween in the winding axial direction α, the eddy current Ie is less likely to be generated.

In the conductor-divided portion 710, the dividing gap 715 between two adjacent divided conductors 711 tends to be a thermal resistance. For example, heat transfer from one of the two divided conductors 711 to the other is likely to be restricted by the dividing gap 715. Therefore, in the conductor-divided portion 710, an effect of heat dissipation in the winding radial direction γ may be reduced by the dividing gap 715. Meanwhile, in the conductor-integrated portion 720, the thermal resistance is reduced due to the absence of the dividing gap 715. Therefore, in the conductor-integrated portion 720, heat generated in the integrated conductor 721 is easily transferred in the winding radial direction γ. Therefore, in the conductor-integrated portion 720, an effect of heat dissipation from the integrated conductor 721 in the winding radial direction γ is high.

Therefore, according to the present embodiment, the conductor-integrated annular portion 703 is provided on the side opposite to the rotors 300a, 300b with the lead-out annular portion 705 and the connection annular portion 706 interposed therebetween. In the configuration, in the coil portion 215, the coil annular portion 701 located at a position where the eddy current Ie is less likely to be generated is the conductor-integrated annular portion 703. Therefore, even if all the coil annular portions 701 in the coil portion 215 are not the conductor-divided annular portions 702, a configuration in which the AC copper loss is less likely to increase can be implemented.

As described above, the conductor-integrated portion 720 has a higher heat dissipation effect in the winding radial direction γ than the conductor-divided portion 710. Therefore, even if the heat dissipation effect in the coil portion 215 in the winding radial direction γ is reduced at the conductor-divided annular portion 702 by the dividing gap 715, the heat dissipation effect in the coil portion 215 in the winding radial direction γ can be improved by the conductor-integrated annular portion 703. Accordingly, a temperature rise in an entire coil portion 215 can be limited.

A volume of the coil conductor 221 in the conductor-integrated annular portion 703 is larger than a volume of the coil conductor 221 in the conductor-divided annular portion 702 by an amount corresponding to the dividing gaps 715 not provided in the conductor-integrated annular portion 703. Therefore, even if the space factor of the coil portion 215 is reduced by the conductor-divided annular portion 702, the space factor of the coil portion 215 can be increased by the conductor-integrated annular portion 703. Accordingly, the DC copper loss in the entire coil portion 215 can be reduced.

In the coil portion 215, the eddy current Ie is also less likely to be generated in the coil annular portion 701 in the intermediate region Ac in addition to the central annular portion 707. Therefore, in the present embodiment, the coil annular portions 701 in the intermediate region Ac are the conductor-integrated annular portions 703. Therefore, for all the coil annular portions 701 in the intermediate region Ac, both improvement in the heat dissipation effect in the winding radial direction γ and reduction in the DC copper loss can be achieved.

In the present embodiment, the motor outer peripheral wall 71 is provided on an outer side of the coil portion 215 in the motor radial direction RD. Therefore, in the coil portion 215, since the effect of heat dissipation from the conductor-integrated annular portion 703 in the winding radial direction γ is improved, the heat can be transmitted from the conductor-integrated annular portion 703 to the motor outer peripheral wall 71 with a low thermal resistance.

According to the present embodiment, the dividing gap 715 is provided between two adjacent divided conductors 711. In the configuration, the eddy current Ie flowing across two adjacent divided conductors 711 is restricted by the gas existing in the dividing gap 715. Therefore, a range in which the eddy current Ie flows can be limited by the dividing gap 715 such that the eddy current Ie individually flows in each of the multiple divided conductors 711.

In the coil annular portion 701, a portion in which the eddy current Ie is likely to be generated and a portion in which the eddy current Ie is less likely to be generated exist. For example, in the coil annular portion 701, in the facing peripheral portions 733, the eddy current Ie is likely to be generated due to the fact that the magnetic flux from the rotors 300a, 300b is likely to interlink. Meanwhile, in the outer-wall-side peripheral portion 731 and the shaft-side peripheral portion 732, the eddy current Ie is less likely to be generated due to the fact that the magnetic flux from the rotors 300a, 300b is less likely to interlink.

Meanwhile, according to the present embodiment, the conductor-divided portion 710 is provided at least in the facing peripheral portions 733 of the coil annular portion 701. In the configuration, in the facing peripheral portions 733 in which the eddy current Ie is likely to be generated, generation of the eddy current Ie can be limited by the conductor-divided portion 710. The limitation of the eddy current Ie in the facing peripheral portions 733 is effective in reducing the AC copper loss in the coil annular portion 701.

According to the present embodiment, the conductor-integrated portion 720 is provided at least in the outer-wall-side peripheral portion 731 and the shaft-side peripheral portion 732 of the coil annular portion 701. In the configuration, in the outer-wall-side peripheral portion 731 and the shaft-side peripheral portion 732 in which the eddy current Ie is less likely to be generated, a decrease in the heat dissipation effect in the winding radial direction γ caused by the dividing gap 715 can be avoided. Accordingly, in the conductor-divided annular portion 702, the eddy current Ie in the facing peripheral portions 733 can be reduced by the conductor-divided portion 710, and the heat dissipation effect in the outer-wall-side peripheral portion 731 and the shaft-side peripheral portion 732 can be improved by the conductor-integrated portion 720. That is, in the conductor-divided annular portion 702, both reduction in the AC copper loss and improvement in the heat dissipation effect can be achieved.

In the double-axial motor 61, since the coil portion 215 is located between the first rotor 300a and the second rotor 300b, the magnetic flux from the rotors 300a, 300b is likely to interlink with the coil portion 215. Therefore, in the coil portion 215, the eddy current Ie is likely to be generated in the coil annular portion 701. Meanwhile, according to the present embodiment, the eddy current Ie in the coil annular portion 701 can be reduced by the divided conductor 711. Therefore, adopting the divided conductor 711 in the double-axial motor 61 in which the eddy current Ie is likely to be generated is effective in reducing the eddy current Ie.

Since the coil portion 215 is located between the first rotor 300a and the second rotor 300b in the motor axial direction AD, it is difficult to release heat of the coil portion 215 in the motor axial direction AD. For this reason, in the double-axial motor 61, the heat dissipation effect in the coil portion 215 may be deteriorated.

Meanwhile, in the present embodiment, the conductor-integrated portion 720 is provided in the outer-wall-side peripheral portion 731 in each of the conductor-divided annular portion 702 and the conductor-integrated annular portion 703. In the conductor-integrated portion 720, heat dissipation toward the motor outer peripheral wall 71 in the motor radial direction RD is not restricted by the dividing gap 715. That is, the heat dissipation from the coil portion 215 to the motor outer peripheral wall 71 is promoted by the conductor-integrated portion 720. In this way, in the double-axial motor 61 in which a direction of the heat dissipation from the coil portion 215 is limited to the motor radial direction RD, it is effective that the effect of heat dissipation from the coil portion 215 to the motor outer peripheral wall 71 is improved by the conductor-integrated portion 720.

According to the present embodiment, the motor 61 drives the eVTOL 10 to fly. In the configuration, a decrease in output of the motor 61 caused by the AC copper loss or the DC copper loss in a state where the eVTOL 10 is flying under driving of the motor 61 can be limited. Therefore, by reducing the loss by the divided conductor 711, safety of the eVTOL 10 can be enhanced.

According to the present embodiment, in the coil portion 215, the divided-conductor ratio OC1 is smaller than the integrated-conductor ratio OC2. In the configuration, due to the fact that the proportion of the coil conductor 221 in the conductor-divided portion 710 is low, the eddy current Ie flowing along the cross-section of the coil conductor 221 tends to be reduced. Therefore, the conductor-divided portion 710 can limit an increase in the AC copper loss caused by an increase in the eddy current Ie.

Due to the fact that the proportion of the coil conductor 221 in the conductor-integrated portion 720 is high, the heat in the conductor-integrated portion 720 is transferred more easily than the heat in the conductor-divided portion 710. That is, the heat dissipation effect in the conductor-integrated portion 720 is higher than the heat dissipation effect in the conductor-divided portion 710. Therefore, the conductor-integrated portion 720 can prevent accumulation of heat in the coil portion 215. In this way, the heat dissipation effect in the coil portion 215 can be improved by the conductor-integrated portion 720.

According to the present embodiment, in the coil annular portion 701, the lane-change-portion conductor thickness TC2 is smaller than the lane-portion conductor thickness TC1. In the configuration, even if the thickness of the annular coating 701b is the same between the lane portion 741 and the lane change portion 742, occurrence of a gap between two coil annular portions 701 adjacent to each other in the motor axial direction AD can be prevented. In other words, it is not necessary to make the annular coating 701b of one of the lane portion 741 and the lane change portion 742 thinner than the annular coating 701b of the other. Therefore, insufficiency in an electrical insulation property of a thinned portion of the annular coating 701b can be avoided. In other words, the thickness of the annular coating 701b required for electrical insulation in the coil annular portion 701 can be secured. Accordingly, in the coil portion 215, the electrical insulation property based on the coil coating 222 can be improved. Increasing the thickness of the annular coating 701b ensures a necessary insulation distance for the annular conductor 701a.

For example, unlike the present embodiment, it is assumed that the lane-portion conductor thickness TC1 and the lane-change-portion conductor thickness TC2 are the same. In the configuration, when the thickness of the annular coating 701b is the same between the lane portion 741 and the lane change portion 742, a gap tends to be generated between two lane portions 741 adjacent to each other in the motor axial direction AD. In response to this, as a method of preventing a gap from being generated between the two lane portions 741, a method of making the annular coating 701b in the lane change portion 742 thinner than the annular coating 701b in the lane portion 741 is considered. However, in this method, an electrical insulation property of the annular coating 701b in the lane change portion 742 may be insufficient.

In the lane change portion 742, when the annular conductor 701a is thinned, increased electrical resistance may make it easier for heat to be generated. Meanwhile, in the present embodiment, the lane change portion 742 is provided at the outer-wall-side peripheral portion 731. Therefore, even if it is easy to generate heat in the lane change portion 742, the heat is easily released to the outside through the motor outer peripheral wall 71. Accordingly, a heat dissipation effect in the lane change portion 742 can be improved.

In the present embodiment, the lane change portion 742 in the winding circumferential direction β is short enough to be included in the outer-wall-side peripheral portion 731. In the configuration, a portion of the coil annular portion 701 in which the annular conductor 701a is thinned can be made as short as possible. Therefore, even if the electric resistance increases at the portion in which the annular conductor 701a is thinned, an increase in the electric resistance can be limited to a slight increase in an entire annular conductor 701a. Accordingly, a temperature rise in the entire annular conductor 701a and a temperature rise at a portion in a wide range can be limited.

In the coil-portion unit 219, the coil coating 222 includes a portion requiring a high electrical insulation property and a portion requiring only an electrical insulation property of a certain degree. For example, due to application of a voltage from the inverter 81 to the electric power lead-out wire 212, the lead-out annular portion 705 of the first coil portion 215a is included in a portion requiring a high electrical insulation property. Meanwhile, due to connection of the neutral lead-out wire 213 to the neutral point 65, the lead-out annular portion 705 of the second coil portion 215b is included in a portion requiring only an electrical insulation property of a certain degree.

Meanwhile, in the present embodiment, the first lead-out coating thickness TIa1 in the coil-portion unit 219 is larger than the second lead-out coating thickness TIa2. Therefore, in the first coil portion 215a, the electrical insulation property in the lead-out annular portion 705 requiring a high electrical insulation property can be improved by thickening the annular coating 701b. Meanwhile, in the second coil portion 215b, a proportion of the annular conductor 701a can be increased and the space factor can be increased by thinning the annular coating 701b in the lead-out annular portion 705 requiring only an electrical insulation property of a certain degree. Accordingly, in the coil-portion unit 219, both limitation in insufficiency of the electrical insulation property and reduction in the DC copper loss can be achieved.

In the first coil portion 215a, the first connection coating thickness TIb1 is smaller than the first lead-out coating thickness TIa1. Therefore, in the first coil portion 215a, the space factor can be increased by thinning the annular coating 701b in the connection annular portion 706 requiring only an electrical insulation property of a certain degree, while increasing the electrical insulation property of the lead-out annular portion 705. Accordingly, in the first coil portion 215a as well, both the limitation in insufficiency of the electrical insulation property and the reduction in the DC copper loss can be achieved.

In the second coil portion 215b, the second connection coating thickness TIb2 is larger than the second lead-out coating thickness TIa2. Therefore, in the second coil portion 215b, the insufficiency in the electrical insulation property can be limited by thickening the annular coating 701b in the connection annular portion 706 requiring only an electrical insulation property of a certain degree, while increasing the space factor in the lead-out annular portion 705. Accordingly, in the second coil portion 215b as well, both the limitation in insufficiency of the electrical insulation property and the reduction in the DC copper loss can be achieved.

### Second Embodiment

In the first embodiment described above, the dividing gap 715 is provided between two adjacent divided conductors 711. Meanwhile, in a second embodiment, an insulation portion is provided between two adjacent divided conductors 711. Configurations, operations, and effects not particularly described in the second embodiment are the same as those in the first embodiment described above. In the second embodiment, differences from the first embodiment will be mainly described.

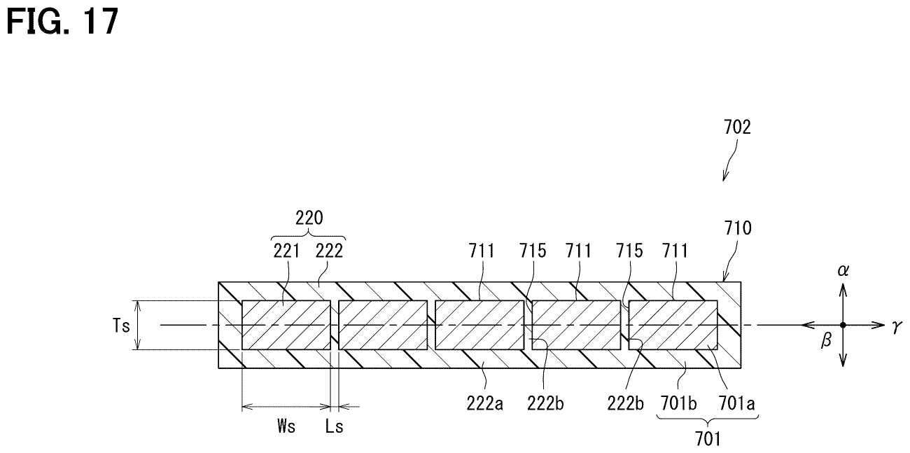

As shown in FIG. 17, the coil coating 222 includes a coating base portion 222a and coating extension portions 222b. Each of the coating base portion 222a and the coating extension portion 222b is made of a resin material or a rubber material and has an electrical insulation property. The coating base portion 222a and the coating extension portion 222b are integrally formed. The coating base portion 222a collectively coats the multiple divided conductors 711. The coating base portion 222a spans the multiple divided conductors 711 in the winding radial direction γ.

Each of the coating extension portions 222b extends inward from the coating base portion 222a so as to enter between two adjacent divided conductors 711. The coating extension portion 222b is provided between two adjacent divided conductors 711, thereby separating the divided conductors 711 from each other. The coating extension portion 222b extends in the winding circumferential direction β along the divided conductor 711. The coating extension portion 222b corresponds to the interposed portion and the insulation portion. Multiple coating extension portions 222b are arranged in the winding radial direction γ. The coating extension portion 222b enters the dividing gap 715 of the first embodiment. The electrical insulation property of the coating extension portion 222b is higher than that of a gas such as air.

According to the present embodiment, the coating extension portion 222b is provided between two adjacent divided conductors 711. In the configuration, the eddy current Ie flowing across two adjacent divided conductors 711 is restricted by the coating extension portion 222b. Therefore, the range in which the eddy current Ie flows can be limited by the coating extension portion 222b such that the eddy current Ie individually flows in each of the multiple divided conductors 711.

The coating extension portion 222b may be a member independent of the coating base portion 222a. For example, the coating base portion 222a may be provided to collectively coat the divided conductors 711 and the coating extension portions 222b in a state where the divided conductors 711 and the coating extension portions 222b are alternately arranged in the winding radial direction γ. As long as the insulation portion such as the coating extension portion 222b has an electrical insulation property, the electrical insulation property of the coating extension portion 222b may be lower than that of a gas such as air. The interposed portion such as the coating extension portion 222b may not be the insulation portion. For example, a conduction property of the interposed portion may be lower than that of the coil conductor 221. Electrical conductivity of the interposed portion may be lower than electrical conductivity of the coil conductor 221. An electrical insulation property of the interposed portion may be higher than that of the coil conductor 221.

### Third Embodiment

In the first embodiment described above, two adjacent divided conductors 711 extend parallel to each other. Meanwhile, in a third embodiment, two adjacent divided conductors 711 intersect each other. Configurations, operations, and effects not particularly described in the third embodiment are the same as those in the first embodiment. In the third embodiment, differences from the first embodiment will be mainly described.

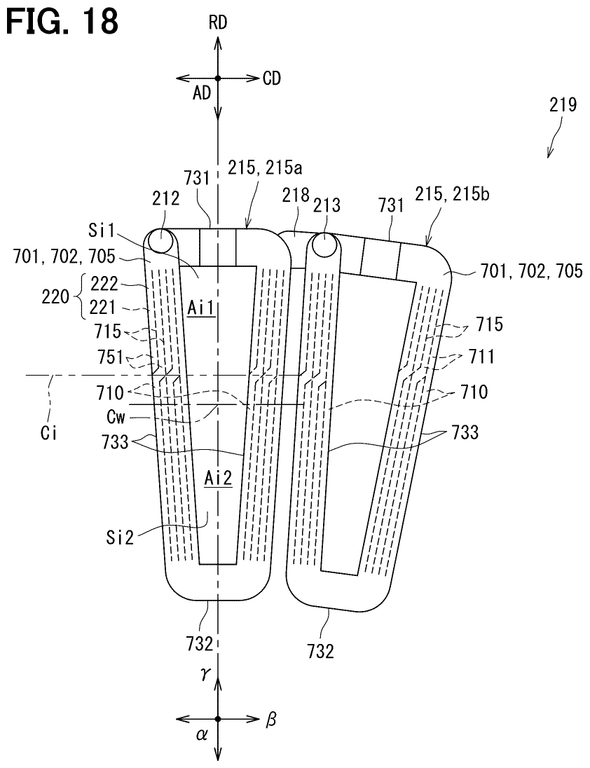

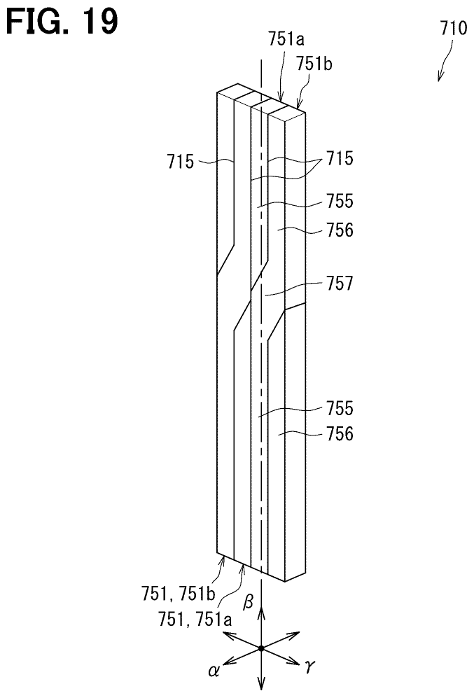

As shown in FIGS. 18 and 19, the conductor-divided portion 710 includes intersecting conductors 751. Multiple intersecting conductors 751 are arranged in a direction orthogonal to the winding circumferential direction β. The intersecting conductors 751 extend in the winding circumferential direction β as a whole. For example, the intersecting conductors 751 extend in the motor radial direction RD as a whole. The multiple intersecting conductors 751 are included in the annular conductor 701a. In the conductor-divided portion 710, the multiple intersecting conductors 751 are formed by dividing the annular conductor 701a into multiple parts in a direction orthogonal to the winding circumferential direction β. The intersecting conductor 751 corresponds to the arranged conductor.

In the conductor-divided portion 710, at least two intersecting conductors 751 intersect each other. In other words, at least two intersecting conductors 751 are dislocated with respect to each other. When the at least two intersecting conductors 751 intersecting each other are referred to as an intersecting set, the conductor-divided portion 710 includes at least one intersecting set. For example, in the conductor-divided portion 710, multiple intersecting sets are arranged in the winding radial direction γ. The at least two intersecting conductors 751 intersect each other in the winding radial direction γ so as to partially overlap each other in the winding axial direction α.

For example, in the conductor-divided portion 710, a first intersecting conductor 751a and a second intersecting conductor 751b intersect each other. The first intersecting conductor 751a and the second intersecting conductor 751b are included in the multiple intersecting conductors 751. The first intersecting conductor 751a and the second intersecting conductor 751b are one intersecting set. The first intersecting conductor 751a and the second intersecting conductor 751b intersect each other in the winding radial direction γ so as to partially overlap each other in the winding axial direction α.

The conductor-divided portion 710 may include at least one divided conductor 711 in addition to the multiple intersecting conductors 751. In the configuration, for example, one intersecting set and one divided conductor 711 are adjacent to each other in the winding circumferential direction β.

As shown in FIGS. 19, 20, and 21, the intersecting conductor 751 includes an outer peripheral conductor 755, an inner peripheral conductor 756, and an inclined conductor 757. Each of the outer peripheral conductor 755 and the inner peripheral conductor 756 extends in the winding circumferential direction β. For example, each of the outer peripheral conductor 755 and the inner peripheral conductor 756 extends substantially straight in the motor radial direction RD. The outer peripheral conductor 755 is provided outward with respect to the inner peripheral conductor 756 in the winding radial direction γ. That is, the outer peripheral conductor 755 is located on an outer peripheral side of the coil portion 215 with respect to the inner peripheral conductor 756. The outer peripheral conductor 755 and the inner peripheral conductor 756 are arranged in the winding circumferential direction β while being displaced in the winding radial direction γ.

The inclined conductor 757 connects the outer peripheral conductor 755 and the inner peripheral conductor 756. The inclined conductor 757 is provided between the outer peripheral conductor 755 and the inner peripheral conductor 756. The inclined conductor 757 is inclined in the winding radial direction γ with respect to the outer peripheral conductor 755 and the inner peripheral conductor 756. In the winding axial direction α, the inclined conductor 757 is thinner than the outer peripheral conductor 755 and the inner peripheral conductor 756. A cross-sectional area of the inclined conductor 757 is the same as a cross-sectional area of the outer peripheral conductor 755 and a cross-sectional area of the inner peripheral conductor 756.

Each of the first intersecting conductor 751a and the second intersecting conductor 751b includes the outer peripheral conductor 755, the inner peripheral conductor 756, and the inclined conductor 757. For example, the first intersecting conductor 751a includes a first outer peripheral conductor 755a, a first inner peripheral conductor 756a, and a first inclined conductor 757a. The second intersecting conductor 751b includes a second outer peripheral conductor 755b, a second inner peripheral conductor 756b, and a second inclined conductor 757b.

In one intersecting set, positions of the outer peripheral conductor 755 and the inner peripheral conductor 756 are reversed in the winding circumferential direction β between at least one intersecting conductor 751 and the remaining intersecting conductor 751. The inclined conductor 757 in the at least one intersecting conductor 751a and the inclined conductor 757 in the remaining intersecting conductor 751 are arranged in the winding axial direction α.

For example, in the first intersecting conductor 751a and the second intersecting conductor 751b, the first outer peripheral conductor 755a and the second outer peripheral conductor 755b are arranged in the winding circumferential direction β, and the first inner peripheral conductor 756a and the second inner peripheral conductor 756b are arranged in the winding circumferential direction β. The first outer peripheral conductor 755a and the second inner peripheral conductor 756b are arranged in the winding radial direction γ, and the second outer peripheral conductor 755b and the first inner peripheral conductor 756a are arranged in the winding radial direction γ. The first inclined conductor 757a and the second inclined conductor 757b are arranged in the winding axial direction α. The first inclined conductor 757a and the second inclined conductor 757b overlap each other in the winding axial direction α.

In the conductor-divided annular portion 702, the first intersecting conductor 751a and the second intersecting conductor 751b are connected by a pair of integrated conductors 721. One of the pair of integrated conductors 721 is provided on an outer side in the motor radial direction RD such as the outer-wall-side peripheral portion 731, and the other is provided on an inner side in the motor radial direction RD such as the shaft-side peripheral portion 732.

In the coil portion 215, the intersecting conductor 751 is disposed similarly to the divided conductor 711 in the first embodiment. For example, in the conductor-divided annular portion 702, the intersecting conductor 751 is provided in the facing peripheral portions 733. The intersecting conductor 751 is provided in the coil annular portions 701 provided in the lead-out region Aa and the connection region Ab.

In the conductor-divided portion 710, intersecting portions of the intersecting conductors 751 are arranged in the winding radial direction γ along an intersecting line Ci. In the intersecting conductor 751, the inclined conductor 757 is the intersecting portion. The intersecting line Ci is a virtual line extending linearly, and extends in the winding radial direction γ through a center of the inclined conductor 757. The intersecting line Ci is orthogonal to both the winding axial direction α and the motor radial direction RD.

For example, the intersecting portions of the first intersecting conductor 751a and the second intersecting conductor 751b are the first inclined conductor 757a and the second inclined conductor 757b. A center of the first inclined conductor 757a and a center of the second inclined conductor 757b are arranged in the winding axial direction α. The first intersecting conductor 751a and the second intersecting conductor 751b are provided at positions where the intersecting line Ci passes through the centers of the inclined conductors 757a, 757b.

As shown in FIG. 18, an outer-wall-side region Ai1 and a shaft-side region Ai2 are set inside the coil portion 215. The outer-wall-side region Ai1 and the shaft-side region Ai2 are arranged in the motor radial direction RD inside the coil annular portion 701. The outer-wall-side region Ai1 and the shaft-side region Ai2 are partitioned by the intersecting line Ci. The outer-wall-side region Ai1 and the shaft-side region Ai2 are set between the pair of facing peripheral portions 733. The outer-wall-side region Ai1 is a region between the outer-wall-side peripheral portion 731 and the intersecting line Ci. The shaft-side region Ai2 is a region between the shaft-side peripheral portion 732 and the intersecting line Ci.

An outer-wall-side area Si1 of the outer-wall-side region Ai1 and a shaft-side area Si2 of the shaft-side region Ai2 are the same. The outer-wall-side area Si1 is an area of the outer-wall-side region Ai1 in a plan view. The shaft-side area Si2 is an area of the shaft-side region Ai2 in a plan view. In the conductor-divided portion 710, the inclined conductor 757 is disposed at a position where the outer-wall-side area Si1 and the shaft-side area Si2 are the same. The inclined conductor 757 is disposed at a magnetic gravity center position in the motor radial direction RD.

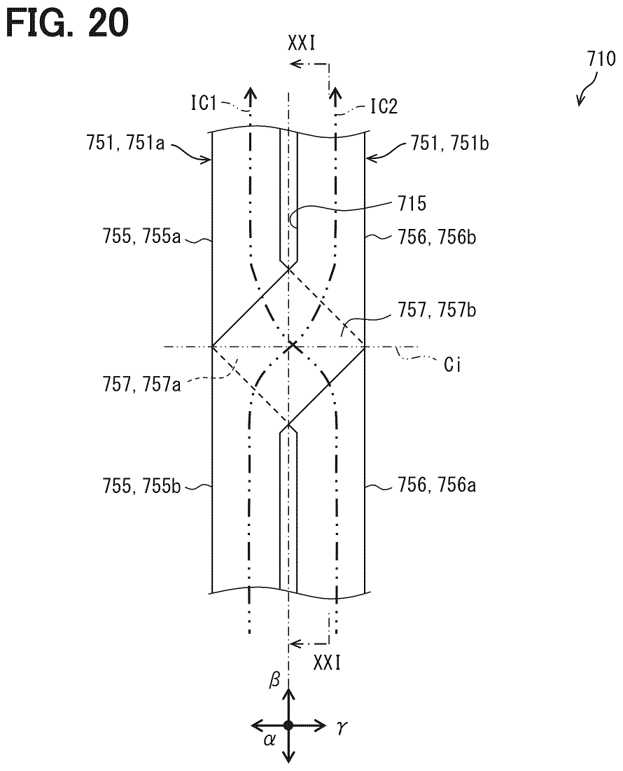

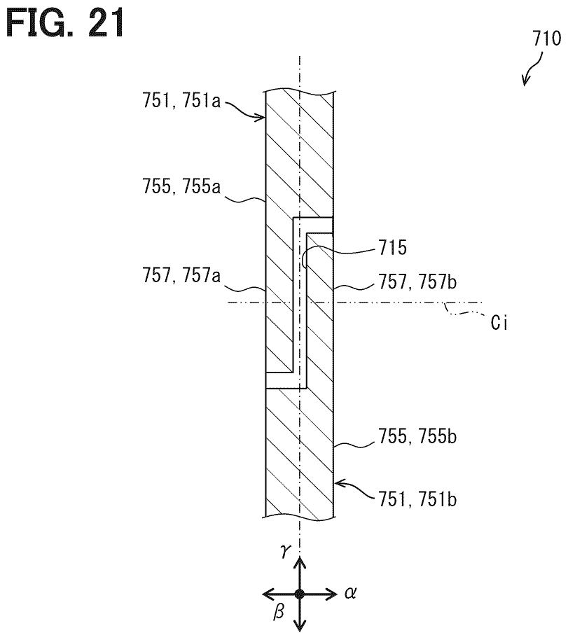

As shown in FIGS. 20 and 21, in the conductor-divided portion 710, the dividing gap 715 is provided between at least two intersecting conductors 751 that intersect each other in one intersecting set. The dividing gap 715 is also provided between two intersecting sets adjacent to each other in the winding radial direction γ. The dividing gap 715 may be provided between the intersecting set and the divided conductor 711.

The dividing gap 715 is provided, for example, between the first intersecting conductor 751a and the second intersecting conductor 751b. The dividing gap 715 is located between the first outer peripheral conductor 755a and the second inner peripheral conductor 756b. The dividing gap 715 is located between the first inner peripheral conductor 756a and the second outer peripheral conductor 755b. The dividing gap 715 is located between the first inclined conductor 757a and the second inclined conductor 757b.

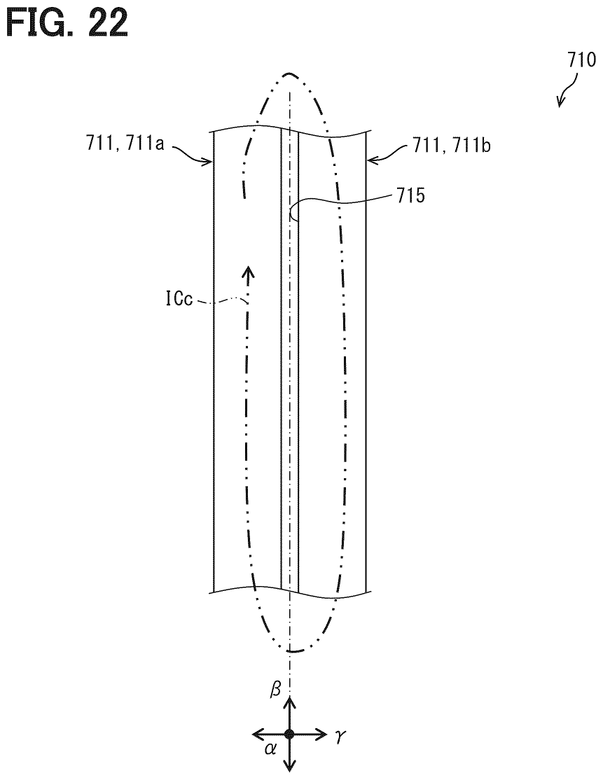

For example, unlike the present embodiment, a comparative example in which multiple divided conductors 711 are connected by the integrated conductor 721 in the conductor-divided annular portion 702 as in the first embodiment is assumed. In the comparative example, as shown in FIG. 22, the multiple divided conductors 711 include a first divided conductor 711a and a second divided conductor 711b. The first divided conductor 711a and the second divided conductor 711b are adjacent to each other in the winding radial direction γ. The first divided conductor 711a and the second divided conductor 711b are connected by the pair of integrated conductors 721. One of the pair of integrated conductors 721 is provided on the outer side in the motor radial direction RD, and the other is provided on the inner side in the motor radial direction RD. In FIG. 22, the integrated conductors 721 are not shown.

In the conductor-divided annular portion 702 of the comparative example, a circulating current IOc may be generated as the rotors 300a, 300b rotate. The circulating current IOc circulates through the first divided conductor 711a, the second divided conductor 711b, the integrated conductor 721 located on the outer side in the motor radial direction RD, and the integrated conductor 721 located on the inner side in the motor radial direction RD. For example, when the magnetic flux from the rotors 300a, 300b interlinks with the divided conductors 711, a radial current flowing in the motor radial direction RD is generated in the divided conductors 711. When the rotors 300a, 300b are rotating, a phase difference occurs between the multiple divided conductors 711 at a phase in which the magnetic flux from the rotors 300a, 300b interlinks with the divided conductors 711.

For example, a phase difference occurs between the radial current generated in the first divided conductor 711a and the radial current generated in the second divided conductor 711b. In this case, the radial current generated in the first divided conductor 711a flows to circulate, as the circulating current IOc, through the first divided conductor 711a, the second divided conductor 711b, and the pair of integrated conductors 721 at a phase earlier than that in which the radial current is generated in the second divided conductor 711b. When the circulating current IOc flows through the conductor-divided annular portion 702 in this way, the AC copper loss in the conductor-divided annular portion 702 may increase.

Meanwhile, in the present embodiment, since the first outer peripheral conductor 755a and the second outer peripheral conductor 755b are arranged in the motor radial direction RD, no phase difference occurs between the first radial current IC1 generated in the first outer peripheral conductor 755a and the second radial current IC2 generated in the second outer peripheral conductor 755b. The first radial current IC1 and the second radial current IC2 flow in the same direction in the motor radial direction RD, thus canceling each other by one integrated conductor 721 in the pair of integrated conductors 721. For example, the first radial current IC1 and the second radial current IC2 cancel each other by the integrated conductor 721 located on the outer side in the motor radial direction RD. In this way, since the first intersecting conductor 751a and the second intersecting conductor 751b intersect each other as described above, the circulating current IOc is less likely to be generated in the conductor-divided annular portion 702. Therefore, the AC copper loss in the conductor-divided annular portion 702 can be reduced.

### Fourth Embodiment

In the third embodiment, the dividing gap 715 is provided between at least two intersecting conductors 751 intersecting each other. Meanwhile, in a fourth embodiment, an insulation portion is provided between at least two intersecting conductors 751 that cross each other. Configurations, operations, and effects not particularly described in the fourth embodiment are the same as those in the first embodiment. In the fourth embodiment, differences from the first embodiment will be mainly described.

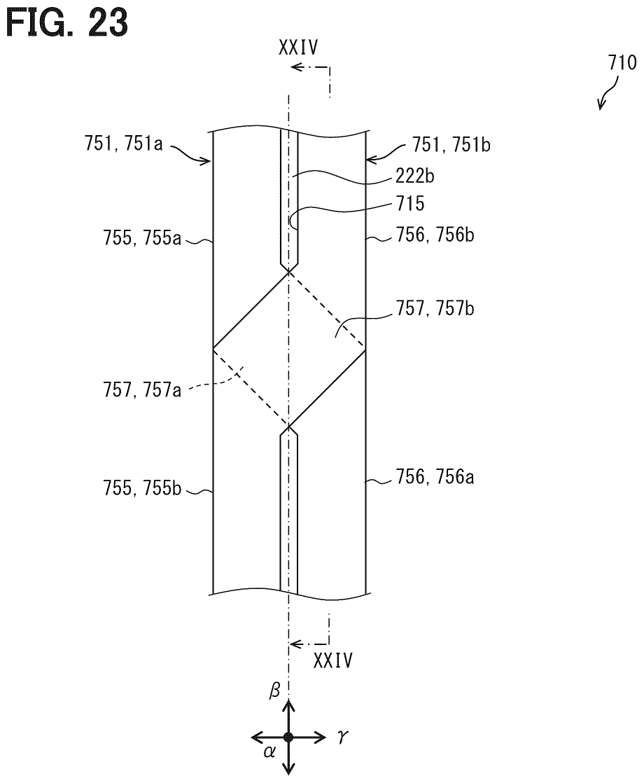

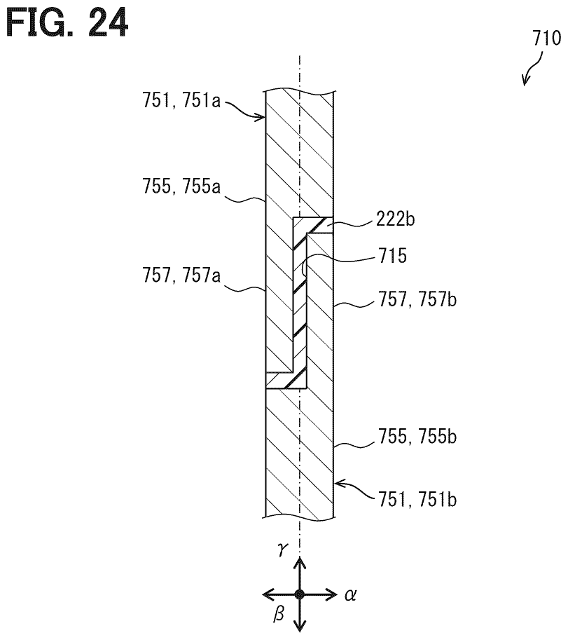

As shown in FIGS. 23 and 24, as in the second embodiment, the coil coating 222 includes the coating base portion 222a and the coating extension portion 222b. The coating extension portion 222b is provided between at least two intersecting conductors 751 intersecting each other. The coating extension portion 222b is also provided between two intersecting sets adjacent to each other in the winding radial direction γ. The coating extension portion 222b may be provided between the intersecting set and the divided conductor 711.

The coating extension portion 222b is provided, for example, between the first intersecting conductor 751a and the second intersecting conductor 751b. The coating extension portion 222b is located between the first outer peripheral conductor 755a and the second inner peripheral conductor 756b. The coating extension portion 222b is located between the first inner peripheral conductor 756a and the second outer peripheral conductor 755b. The coating extension portion 222b is located between the first inclined conductor 757a and the second inclined conductor 757b.

### Fifth Embodiment

In the first embodiment described above, in the coil annular portion 701, a difference in the conductor ratio occurs depending on the presence or absence of the dividing gap 715. Meanwhile, in a fifth embodiment, in the coil annular portion 701, a difference in the conductor ratio occurs depending on a volume density of the annular conductor 701a. Configurations, operations, and effects not particularly described in the fifth embodiment are the same as those of the first embodiment. In the fifth embodiment, differences from the first embodiment will be mainly described.

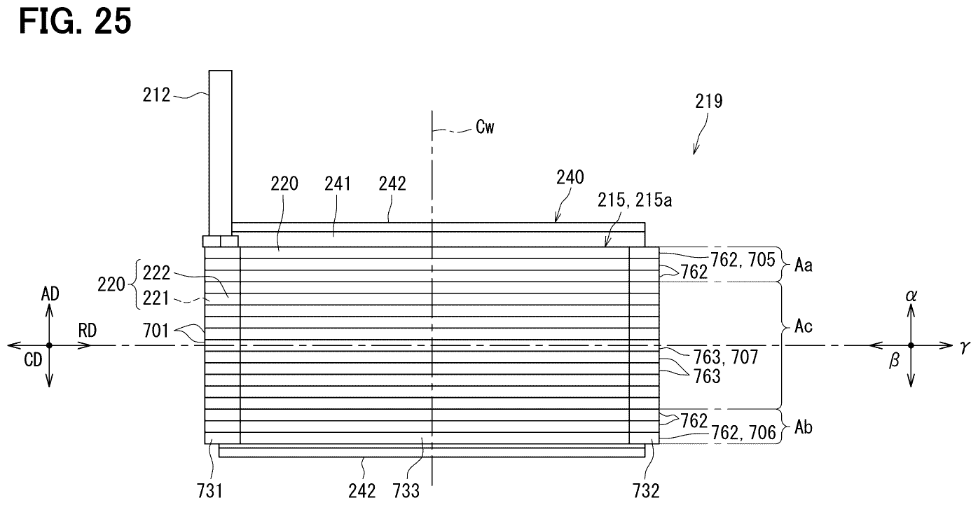

As shown in FIG. 25, the multiple coil annular portions 701 include non-uniform annular portions 762 and uniform annular portions 763. In each of the non-uniform annular portions 762, the volume density of at least a part of the annular conductor 701a is set to be low. For example, in the non-uniform annular portion 762, the volume density of the annular conductor 701a is not uniform. The volume density [kg/m3] is a mass per unit volume. In each of the uniform annular portions 763, the volume density of the annular conductor 701a is set to be high. For example, in the uniform annular portion 763, the volume density of the annular conductor 701a is uniform.

In the coil portion 215 of the present embodiment, the non-uniform annular portion 762 is provided instead of the conductor-divided annular portion 702 of the first embodiment. The uniform annular portion 763 is provided instead of the conductor-integrated annular portion 703 of the first embodiment. For example, the non-uniform annular portion 762 is provided in the lead-out region Aa and the connection region Ab, and the uniform annular portion 763 is provided in the intermediate region Ac.

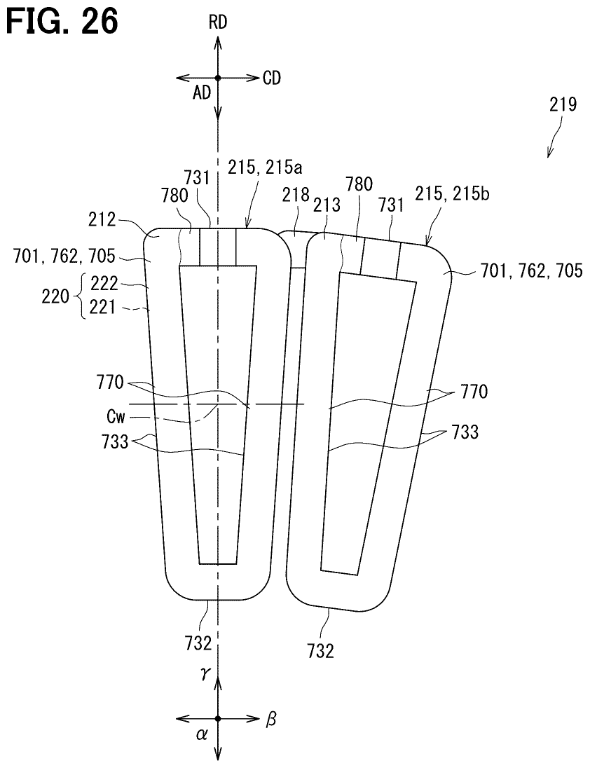

As shown in FIGS. 26 to 28, the non-uniform annular portion 762 includes a first density portion 770 and a second density portion 780. The first density portion 770 includes a first density conductor 771 in addition to the annular coating 701b. The first density conductor 771 extends in the winding circumferential direction β. In the first density portion 770, one first density conductor 771 is formed by not dividing the annular conductor 701a into multiple parts.

The second density portion 780 includes a second density conductor 781 in addition to the annular coating 701b. The second density conductor 781 extends in the winding circumferential direction β. In the second density portion 780, one second density conductor 781 is formed by not dividing the annular conductor 701a into multiple parts.

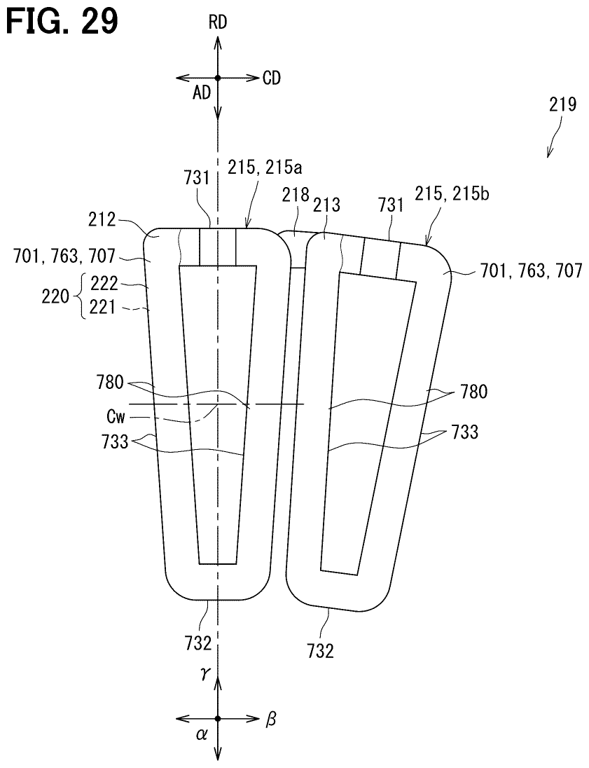

In the coil portion 215 of the present embodiment, the first density portion 770 is provided instead of the conductor-divided portion 710 of the first embodiment. The second density portion 780 is provided instead of the conductor-integrated portion 720 of the first embodiment. As shown in FIG. 26, in the non-uniform annular portion 762, the second density portion 780 is provided in the outer-wall-side peripheral portion 731 and the shaft-side peripheral portion 732, and the second density portion 780 is provided in the facing peripheral portions 733. As shown in FIG. 29, in the uniform annular portion 763, the second density portion 780 extends in an annular shape in the winding circumferential direction β.

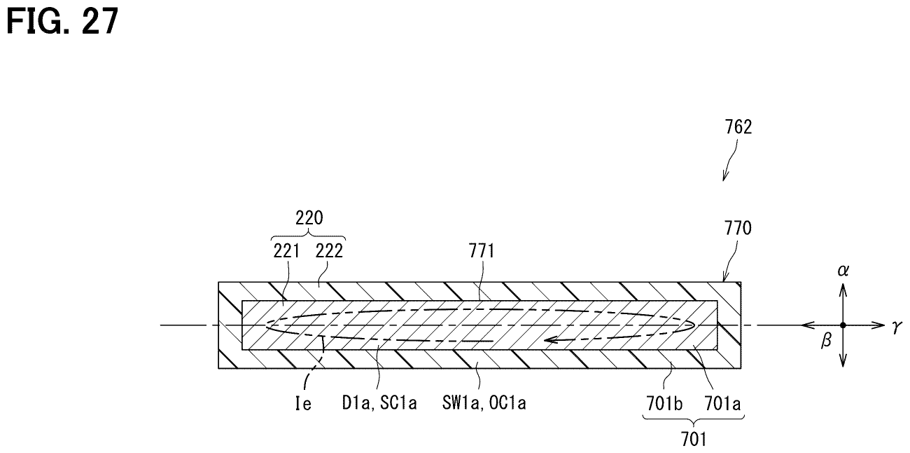

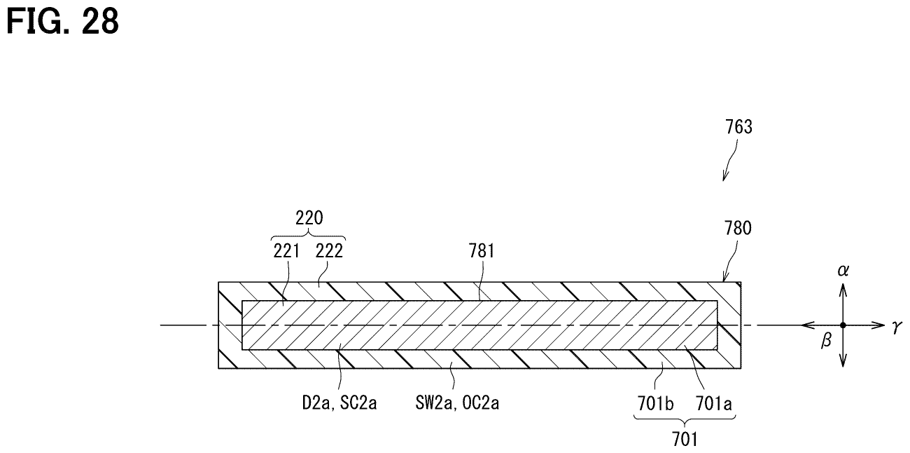

In FIGS. 27 and 28, a first density D1a of the first density conductor 771 is smaller than a second density D2a of the second density conductor 781. The first density D1a is a volume density of the first density conductor 771. The second density D2a is a volume density of the second density conductor 781. Many minute gaps exist in the first density conductor 771 and the second density conductor 781. In the first density conductor 771, there are more or larger minute gaps than in the second density conductor 781, and thus the first density D1a is smaller than the second density D2a.

A first conductor ratio OC1a of the first density portion 770 is smaller than a second conductor ratio OC2a of the second density portion 780. The first conductor ratio OC1a is a value corresponding to the first density D1a. As the first density D1a decreases, the first conductor ratio OC1a decreases. The second conductor ratio OC2a is a value corresponding to the second density D2a. As the second density D2a increases, the second conductor ratio OC2a increases. Accordingly, the first density D1a is smaller than the second density D2a, and thus the first conductor ratio OC1a is also smaller than the second conductor ratio OC2a.

The first conductor ratio OC1a is a proportion of the first density conductor 771 in a cross-section of the first density portion 770. For example, the first conductor ratio OC1a is a proportion of a cross-sectional area SC1a of the first density conductor 771 in a cross-sectional area SW1a of the first density portion 770. The cross-sectional area SW1a includes a cross-sectional area of the coil coating 222 and an actual cross-sectional area of the first density conductor 771. The actual cross-sectional area of the first density conductor 771 is a value corresponding to the first density D1a. For example, with respect to the cross-sectional area of the first density conductor 771, the actual cross-sectional area of the first density conductor 771 decreases as the first density D1a decreases. That is, in the first density conductor 771, the actual cross-sectional area decreases with respect to the cross-sectional area due to the more or larger minute gaps. That is, in the first density conductor 771, the first density D1a is smaller, and thus the first conductor ratio OC1a is smaller.

The second conductor ratio OC2a is a proportion of the second density conductor 781 in a cross-section of the second density portion 780. For example, the second conductor ratio OC2a is a proportion of a cross-sectional area SC2a of the second density conductor 781 in a cross-sectional area SW2a of the second density portion 780. The cross-sectional area SW2a includes a cross-sectional area of the coil coating 222 and an actual cross-sectional area of the second density conductor 781. The actual cross-sectional area of the second density conductor 781 is a value corresponding to the second density D2a. For example, with respect to the cross-sectional area of the second density conductor 781, the actual cross-sectional area of the second density conductor 781 increases as the second density D2a increases. That is, in the second density conductor 781, there are fewer or smaller minute gaps, and thus the actual cross-sectional area increases with respect to the cross-sectional area. That is, in the second density conductor 781, the second density D2a is larger, and thus the second conductor ratio OC2a is larger.

For example, in the first density portion 770 and the second density portion 780, the cross-sectional areas SW1a, SW2a are the same. Meanwhile, the first density D1a is smaller than the second density D2a, and thus the first conductor ratio OC1a is smaller than the second conductor ratio OC2a. The first density portion 770 corresponds to the first occupancy portion, and the second density portion 780 corresponds to the second occupancy portion.

As in the first embodiment, in the coil portion 215, the eddy current Ie may be generated in the coil conductor 221. As shown in FIG. 27, when the eddy current Ie is generated in the first density portion 770, the eddy current Ie flows along a cross-section of the first density conductor 771. In the first density portion 770, the eddy current Ie may increase due to the fact that the cross-sectional area of the first density conductor 771 is large.

Meanwhile, according to the present embodiment, in the coil portion 215, the first conductor ratio OC1a is smaller than the second conductor ratio OC2a. In the configuration, due to the fact that the proportion of the coil conductor 221 in the first density portion 770 is low, the eddy current Ie flowing along the cross-section of the coil conductor 221 tends to decrease. Therefore, the first density portion 770 can limit the increase in the AC copper loss caused by the increase in the eddy current Ie.

Due to the fact that the proportion of the coil conductor 221 in the second density portion 780 is high, the heat in the second density portion 780 is transferred more easily than the heat in the first density portion 770. That is, the heat dissipation effect in the second density portion 780 is higher than the heat dissipation effect in the first density portion 770. Therefore, the second density portion 780 can prevent accumulation of heat in the coil portion 215. In this way, the heat dissipation effect in the coil portion 215 can be improved by the second density portion 780.

When minute gaps exist in the coil conductor 221, it is difficult for the eddy current Ie to flow through the minute gaps in the coil conductor 221 due to the presence of a gas such as air in the minute gaps. Therefore, in the coil conductor 221, the eddy current Ie decreases due to the more or larger minute gaps.

Therefore, according to the present embodiment, in the coil portion 215, the first density D1a is smaller than the second density D2a. In the configuration, it is difficult for the eddy current Ie to flow in the first density portion 770 than in the second density portion 780 due to more or larger minute gaps. Therefore, even if the eddy current Ie is generated in the first density portion 770, the eddy current Ie is blocked by the minute gaps and is less likely to increase. Accordingly, the first density portion 770 can limit the increase in the eddy current loss and the AC copper loss caused by the increase in the eddy current Ie.

In the first density portion 770, even when the first density D1a is small, an overall shape of the coil conductor 221, which is a plate shape, is maintained. Therefore, in the first density portion 770, since the cross-section of the coil conductor 221 is increased, the electric resistance of the coil conductor 221 is also unlikely to increase. Accordingly, the increase in the DC copper loss can also be limited in the first density portion 770.

### Sixth Embodiment

In the first embodiment described above, the lane-portion conductor thickness TC1 is uniform among the multiple coil annular portions 701. Meanwhile, in a sixth embodiment, the lane-portion conductor thickness TC1 is not uniform among the multiple coil annular portions 701. Configurations, operations, and effects not particularly described in the sixth embodiment are the same as those in the first embodiment. In the sixth embodiment, differences from the first embodiment will be mainly described.

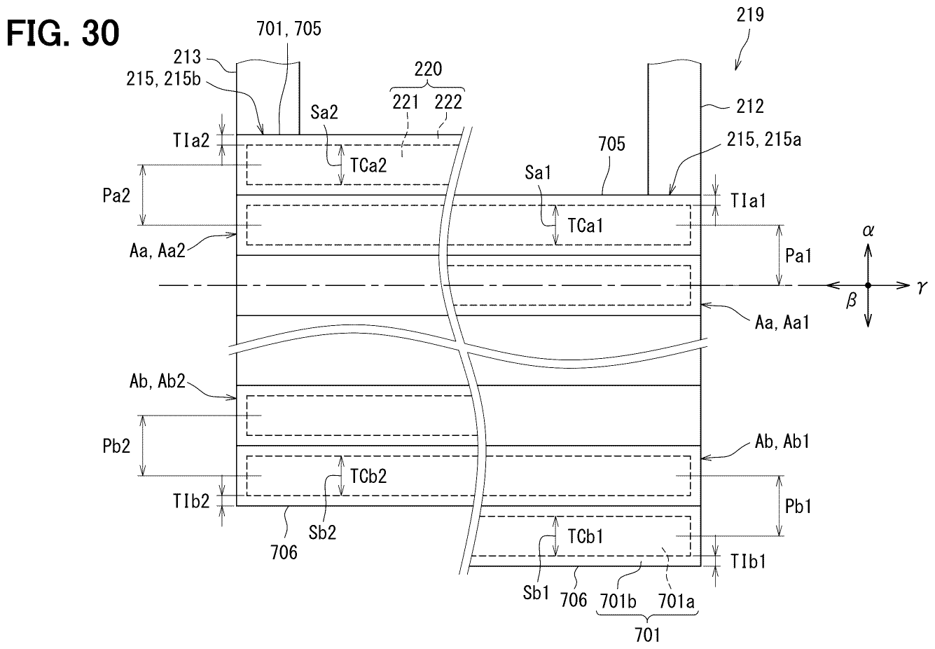

In the coil-portion unit 219, the lane-portion conductor thickness TC1 is not uniform in the first coil portion 215a and the second coil portion 215b. As shown in FIG. 30, in the coil-portion unit 219, a first lead-out conductor thickness TCa1 in the first lead-out region Aa1 is smaller than a second lead-out conductor thickness TCa2 in the second lead-out region Aa2. That is, a relationship of TCa1<TCa2 is established. The first lead-out conductor thickness TCa1 is the thickness of the annular conductor 701a in the first lead-out region Aa1. The second lead-out conductor thickness TCa2 is the thickness of the annular conductor 701a in the second lead-out region Aa2. The first lead-out conductor thickness TCa1 and the second lead-out conductor thickness TCa2 are the lane-portion conductor thickness TC1.

In the coil-portion unit 219, the cross-sectional area of the annular conductor 701a is not uniform between the first coil portion 215a and the second coil portion 215b. In the coil-portion unit 219, a first lead-out cross-sectional area Sa1 in the first lead-out region Aa1 is smaller than a second lead-out cross-sectional area Sa2 in the second lead-out region Aa2. That is, a relationship of Sa1<Sa2 is established. In the coil-portion unit 219, the relationship of TCa1<TCa2 is established, and thus the relationship of Sa1<Sa2 is established. The first lead-out cross-sectional area Sal is the cross-sectional area of the annular conductor 701a in the first lead-out region Aa1. The second lead-out cross-sectional area Sa2 is the cross-sectional area of the annular conductor 701a in the second lead-out region Aa2.

In the coil-portion unit 219, the pitch of the annular conductor 701a is uniform between the first coil portion 215a and the second coil portion 215b. For example, the first lead-out pitch Pa1 and the second lead-out pitch Pa2 are the same. That is, a relationship of Pa1=Pa2 is established.

Meanwhile, the thickness of the annular coating 701b is not uniform between the first coil portion 215a and the second coil portion 215b. For example, as in the first embodiment, the first lead-out coating thickness TIa1 is larger than the second lead-out coating thickness TIa2. In the coil-portion unit 219, the relationship of TCa1<TCa2 is established, a relationship of Pa1=Pa2 is established, and thus the relationship of TIa1>TIb1 is established.

In the present embodiment, as in the first embodiment, the first lead-out coating thickness TIa1 is larger than the second lead-out coating thickness TIa2. Therefore, as in the first embodiment, the electrical insulation property can be increased in the first coil portion 215a, and the space factor can be increased in the second coil portion 215b.

As long as the relationship of TCa1<TCa2 is established, the lane-portion conductor thickness TC1 may be uniform or may not be uniform in the first coil portion 215a. For example, a first connection conductor thickness TCb1 in the first connection region Ab1 may be the same as the first lead-out conductor thickness TCa1 or may be larger than the first lead-out conductor thickness TCa1. The first connection conductor thickness TCb1 is the thickness of the annular conductor 701a in the first connection region Ab1. The first connection conductor thickness TCb1 is the lane-portion conductor thickness TC1.

As long as the relationship of TCa1<TCa2 is established, the lane-portion conductor thickness TC1 may be uniform or may not be uniform in the second coil portion 215b. For example, the second connection conductor thickness TCb2 in the second connection region Ab2 may be the same as the second lead-out conductor thickness TCa2 or may be larger than the second lead-out conductor thickness TCa2. The second connection conductor thickness TCb2 is the thickness of the annular conductor 701a in the second connection region Ab2. The second connection conductor thickness TCb2 is the lane-portion conductor thickness TC1.

### Other Embodiments

The disclosure in the present description is not limited to the illustrated embodiments. The disclosure encompasses the illustrated embodiments and modifications thereof made by those skilled in the art. For example, the disclosure is not limited to the combination of components and elements described in the embodiments, and various modifications and implementations can be performed. The disclosure may be implemented in various combinations. The disclosure may have an additional portion that can be added to the embodiments. The disclosure encompasses the omission of components and elements of the embodiments. The disclosure encompasses the replacement or combination of components, elements between one embodiment and another embodiment. The disclosed technical scope is not limited to those described in the embodiments. The disclosed technical scope is indicated by the description of the claims, and should be construed to include all changes within the meaning and range equivalent to the description of the claims.

In each of the embodiments described above, the conductor-arranged portion such as the conductor-divided portion 710 and the first occupancy portion such as the first density portion 770 may be provided at any position in the coil portion 215. For example, in the first embodiment described above, the conductor-divided portion 710 may be provided at any position in the outer-wall-side peripheral portion 731, the shaft-side peripheral portion 732, and the facing peripheral portions 733 in the coil annular portion 701. For example, the conductor-divided portion 710 may extend in an annular shape in the winding circumferential direction β so as to be provided in all of the outer-wall-side peripheral portion 731, the shaft-side peripheral portion 732, and the facing peripheral portions 733. The conductor-divided portion 710 may be provided only in the outer-wall-side peripheral portion 731. Similarly to the conductor-divided portion 710, the first density portion 770 of the fifth embodiment described above may also be provided at any position of the coil annular portion 701.

In the first embodiment described above, the conductor-divided portion 710 may be provided in any coil annular portion 701 among the multiple coil annular portions 701 in the coil portion 215. For example, the conductor-divided portions 710 may be provided in all the coil annular portions 701. The conductor-divided portion 710 may be provided only in the lead-out annular portion 705 and the connection annular portion 706 among the multiple coil annular portions 701. Similarly to the conductor-divided portion 710, the first density portion 770 of the fifth embodiment described above may also be provided in any coil annular portion 701 among the multiple coil annular portions 701.

In each of the embodiments described above, at least one of the conductor-divided portion 710, the conductor-integrated portion 720, the first density portion 770, and the second density portion 780 may be provided in the coil portion 215. For example, the multiple coil annular portions 701 may include both the conductor-divided annular portion 702 and the non-uniform annular portion 762. In the coil annular portion 701, the conductor-divided portion 710 and the first density portion 770 may be arranged in the winding circumferential direction β.

In each of the embodiments described above, the shape and size of the coil wire 220 may be any shape and size. For example, in the first embodiment described above, the pitch of the annular conductor 701a may be uniform in the coil portion 215. In the coil portion 215, the thickness of the annular coating 701b may be uniform. In the coil portion 215, the coil annular portion 701 may be lane-changed at any position in the winding circumferential direction β.

In each of the embodiments described above, the motor device 60 and the inverter device 80 may share the housing. For example, both the motor 61 and the inverter 81 may be accommodated in a common housing. The motor device 60 and the inverter device 80 may not be integrated. For example, the motor housing 70 and the inverter housing 90 may not be integrated.

In each of the embodiments described above, the eVTOL 10 may be configured such that at least one propeller 20 is driven by at least one EPU 50. For example, one propeller 20 may be driven by multiple EPUs 50, or multiple propellers 20 may be driven by one EPU 50.

In each of the embodiments described above, the eVTOL 10 may not be a tilt-rotor aircraft. For example, in the eVTOL 10, the multiple propellers 20 may include a lift-propeller 20 and a cruise-propeller 20. In the eVTOL 10, for example, the lift-propeller 20 is driven when ascending, and the cruise-propeller 20 is driven when moving forward.

In each of the embodiments described above, the flight vehicle on which the EPU 50 is mounted may not be the vertical take-off and landing aircraft as long as being of an electric type. For example, the flight vehicle may be a flight vehicle capable of taking off and landing while gliding, as an example of the electric aircraft. The flight vehicle may be a rotorcraft, or a fixed-wing aircraft. The flight vehicle may be an unmanned flight vehicle carrying no person.

In each of the embodiments described above, the moving object on which the EPU 50 is mounted may not be a flight vehicle as long as the moving object is movable by rotation of the rotary body. For example, the moving object may be a vehicle, a ship, a construction machine, or an agricultural machine. For example, when the moving object is a vehicle, a construction machine, or the like, the rotary body is a movement-wheel or the like, and an output shaft portion is an axle or the like. When the moving object is a ship, the rotary body is a propulsion-screw propeller or the like, and the output shaft portion is a propeller shaft or the like.

### Disclosure of Technical Ideas

This description discloses multiple technical ideas described in multiple items listed below. Some items may be written in a multiple dependent form with subsequent items referring to the preceding item as an alternative. Some items may be written in a multiple dependent form referring to another multiple dependent form. These items written in a multiple dependent form define multiple technical ideas.

### Technical Idea 1

A rotary electric machine (60) is to be driven by supply of electric power. The rotary electric machine comprises: a rotor (300a, 300b) configured to rotate about a rotation axis (Cm); and a stator (200) adjacent to the rotor along the rotation axis and including a coil portion (215) in which a plate-shaped coil wire (220) is wound to be stacked in an axial direction (AD) of the rotation axis. The coil portion includes a conductor-arranged portion (710) in which a conductor (221) of the coil wire is divided into a plurality of parts. The conductor-arranged portion includes a plurality of arranged conductors (711, 751) arranged in a direction (α, γ) orthogonal to a winding direction (β) of the coil wire, and an interposed portion (715, 222b) provided between two of the arranged conductors adjacent to each other, and separating the arranged conductors from each other.

### Technical Idea 2

The rotary electric machine is according to the technical idea 1. The plurality of arranged conductors include, as the two of the arranged conductors adjacent to each other, width-direction arranged conductors (711) arranged in a width direction (γ) of the coil wire.

### Technical Idea 3

The rotary electric machine is according to the technical idea 1 or 2. The coil portion includes a radial extension portion (733), in which the coil wire extends in a radial direction (RD) of the rotation axis, and a circumferential extension portion (731, 732), in which the coil wire extends in a circumferential direction (CD) of the rotation axis. The conductor-arranged portion is provided in at least the radial extension portion out of the radial extension portion and the circumferential extension portion.

### Technical Idea 4

The rotary electric machine is according to the technical idea 3. The coil portion includes a conductor-integrated portion (720), which is arranged adjacent to the conductor-arranged portion in the winding direction and in which the conductor of the coil wire is not divided. The conductor-integrated portion is provided in at least the circumferential extension portion out of the radial extension portion and the circumferential extension portion.

### Technical Idea 5

The rotary electric machine is according to any one of the technical ideas 1 to 4. The plurality of arranged conductors include, as the two of the arranged conductors adjacent to each other, two intersecting conductors (751a, 751b) intersecting with each other.

### Technical Idea 6

The rotary electric machine is according to any one of the technical ideas 1 to 5. The coil portion includes a plurality of coil annular portions (701) formed by the coil wire, each extending in an annular shape in the winding direction, and arranged in the axial direction. The plurality of coil annular portions include a conductor-arranged annular portion (702) including the conductor-arranged portion. At least a closest annular portion (705, 706), which is closest to the rotor in the axial direction among the plurality of coil annular portions, is the conductor-arranged annular portion.

### Technical Idea 7

The rotary electric machine is according to the technical idea 6. The plurality of coil annular portions include a conductor-integrated annular portion (703) that does not include the conductor-arranged portion. The conductor-integrated annular portion is provided on a side opposite to the rotor with the closest annular portion interposed therebetween.

### Technical Idea 8

The rotary electric machine is according to any one of the technical ideas 1 to 7. The interposed portion is a gap (715) between the two of the arranged conductors adjacent to each other.

### Technical Idea 9

The rotary electric machine is according to any one of the technical ideas 1 to 8. The interposed portion is an insulation portion (222b) having an electrical insulation property and provided between the two of the arranged conductors adjacent to each other.

### Technical Idea 10

A rotary electric machine (60) is to be driven by supply of electric power. The rotary electric machine comprises: a rotor (300a, 300b) configured to rotate about a rotation axis (Cm); and a stator (200) adjacent to the rotor along the rotation axis and including a coil portion (215) in which a plate-shaped coil wire (220) is wound to be stacked in an axial direction (AD) of the rotation axis. The coil portion includes: a first occupancy portion (710, 770) in which a proportion of a conductor (221) in a cross-section of the coil wire is a first conductor ratio (OC1, OC1a), and a second occupancy portion (720, 780) adjacent to the first occupancy portion in a winding direction (β) of the coil wire and in which the proportion is a second conductor ratio (OC2, OC2a). The first conductor ratio is smaller than the second conductor ratio.

### Technical Idea 11

The rotary electric machine is according to the technical idea 10. The first conductor ratio is smaller than the second conductor ratio by setting a volume density (D1a) of the conductor in the first occupancy portion to be smaller than a volume density (D2a) of the conductor in the second occupancy portion.

### Technical Idea 12

The rotary electric machine is according to the technical idea 10 or 11. The coil portion includes a radial extension portion (733), in which the coil wire extends in a radial direction (RD) of the rotation axis, and a circumferential extension portion (731, 732), in which the coil wire extends in a circumferential direction (CD) of the rotation axis. The first occupancy portion is provided in at least the radial extension portion out of the radial extension portion and the circumferential extension portion. The second occupancy portion is provided in at least the circumferential extension portion out of the radial extension portion and the circumferential extension portion.

### Technical Idea 13

The rotary electric machine is according to any one of the technical ideas 1 to 12. The coil portion includes a plurality of lane portions (741) formed by the coil wire, each extending in the winding direction to be orthogonal to the rotation axis, and arranged in the axial direction, and a lane inclination portion (742) formed by the coil wire, inclined in the axial direction with respect to the lane portions, and connecting two of the lane portions adjacent to each other in the axial direction. A thickness (TC2) of the lane inclination portion is smaller than a thickness (TC1) of each of the lane portions.

### Technical Idea 14

The rotary electric machine is according to any one of the technical ideas 1 to 13. The rotor includes a first rotor (300a) and a second rotor (300b), which is adjacent to the first rotor in the axial direction. The coil portion is provided between the first rotor and the second rotor.

### Technical Idea 15

The rotary electric machine is according to any one of the technical ideas 1 to 14. The rotary electric machine is provided in a flight vehicle (10) and configured to drive the flight vehicle to fly.

What is claimed is:

1. A rotary electric machine to be driven by supply of electric power, the rotary electric machine comprising:
a rotor configured to rotate about a rotation axis; and
a stator including a coil portion in which a plate-shaped coil wire is wound to be stacked, wherein
the coil portion includes a conductor-arranged portion in which a conductor of the coil wire is divided into a plurality of parts, and
the conductor-arranged portion includes
a plurality of arranged conductors arranged in a direction orthogonal to a winding direction of the coil wire,
a coating portion that spans the plurality of arranged conductors and coats the arranged conductors together, and
an interposed portion that is inside the coating portion, provided between two of the arranged conductors adjacent to each other, and separating the arranged conductors from each other.

2. The rotary electric machine according to claim 1, wherein
the plurality of arranged conductors include, as the two of the arranged conductors adjacent to each other, width-direction arranged conductors arranged in a width direction of the coil wire.

3. The rotary electric machine according to claim 1, wherein
the coil portion includes a radial extension portion, in which the coil wire extends in a radial direction of the rotation axis, and a circumferential extension portion, in which the coil wire extends in a circumferential direction of the rotation axis, and
the conductor-arranged portion is provided in at least the radial extension portion out of the radial extension portion and the circumferential extension portion.

4. The rotary electric machine according to claim 3, wherein
the coil portion includes a conductor-integrated portion, which is arranged adjacent to the conductor-arranged portion in the winding direction and in which the conductor of the coil wire is not divided, and
the conductor-integrated portion is provided in at least the circumferential extension portion out of the radial extension portion and the circumferential extension portion.

5. The rotary electric machine according to claim 1, wherein
the plurality of arranged conductors include, as the two of the arranged conductors adjacent to each other, two intersecting conductors intersecting with each other.

6. The rotary electric machine according to claim 1, wherein
the coil portion includes a plurality of coil annular portions formed by the coil wire, each extending in an annular shape in the winding direction, and arranged in a stack direction, in which the coil wire is stacked,
the plurality of coil annular portions include a conductor-arranged annular portion including the conductor-arranged portion, and
at least an outer annular portion, which is on an outermost side in the stack direction among the plurality of coil annular portions, is the conductor-arranged annular portion.

7. The rotary electric machine according to claim 6, wherein
the plurality of coil annular portions include a conductor-integrated annular portion that does not include the conductor-arranged portion, and
the conductor-integrated annular portion is provided on an inner side of the outer annular portion in the stack direction.

8. The rotary electric machine according to claim 1, wherein
the interposed portion is a gap between the two of the arranged conductors adjacent to each other.

9. The rotary electric machine according to claim 1, wherein
the interposed portion is an insulation portion having an electrical insulation property and provided between the two of the arranged conductors adjacent to each other.

10. A rotary electric machine to be driven by supply of electric power, the rotary electric machine comprising:
a rotor configured to rotate about a rotation axis; and
a stator including a coil portion in which a plate-shaped coil wire is wound to be stacked, wherein
the coil portion includes:
a first occupancy portion including a conductor of a lump in which a proportion of the conductor in a cross-section of the coil wire is a first conductor ratio, and
a second occupancy portion including a conductor of a lump, adjacent to the first occupancy portion in a winding direction of the coil wire, and in which the proportion is a second conductor ratio, and
the first conductor ratio is smaller than the second conductor ratio.

11. The rotary electric machine according to claim 10, wherein
the first conductor ratio is smaller than the second conductor ratio by setting a volume density of the conductor in the first occupancy portion to be smaller than a volume density of the conductor in the second occupancy portion.

12. The rotary electric machine according to claim 10, wherein
the first conductor ratio is smaller than the second conductor ratio by setting a form of a gap, which exists in the conductor of the first occupancy portion, to be different from a form of a gap, which exists in the conductor of the second occupancy portion.

13. The rotary electric machine according to claim 10, wherein
the coil portion includes a radial extension portion, in which the coil wire extends in a radial direction of the rotation axis, and a circumferential extension portion, in which the coil wire extends in a circumferential direction of the rotation axis,
the first occupancy portion is provided in at least the radial extension portion out of the radial extension portion and the circumferential extension portion, and
the second occupancy portion is provided in at least the circumferential extension portion out of the radial extension portion and the circumferential extension portion.

14. The rotary electric machine according to claim 1, wherein
the coil portion includes
a plurality of lane portions formed by the coil wire, each extending in the winding direction to be orthogonal to the rotation axis, and arranged in a stack direction, in which the coil wire is stacked, and
a lane inclination portion formed by the coil wire, inclined in the stack direction with respect to the lane portions, and connecting two of the lane portions adjacent to each other in the stack direction, and
a thickness of the lane inclination portion is smaller than a thickness of each of the lane portions.

15. The rotary electric machine according to claim 10, wherein
in the coil portion, the coil wire is wound to be stacked in an axial direction of the rotation axis, and
the stator is adjacent to the rotor along the rotation axis.

16. The rotary electric machine according to claim 1, wherein
the rotor includes a first rotor and a second rotor, which is adjacent to the first rotor in an axial direction of the rotation axis, and
the coil portion is provided between the first rotor and the second rotor.

17. The rotary electric machine according to claim 1, wherein
the rotary electric machine is provided in a flight vehicle and configured to drive the flight vehicle to fly.
